(19) United States
(12) Patent Application Publication
(10) Pub. No.: US 2022/0142422 A1
(43) Pub. Date: May 12, 2022

(54) AUTOMATIC MULTI-ATTACHMENT CHANGING STATION

(71) Applicant: Mark Jeffery GIARRITTA, Foresthill, CA (US)

(72) Inventor: Mark Jeffery GIARRITTA, Foresthill, CA (US)

(21) Appl. No.: 17/519,781

(22) Filed: Nov. 5, 2021

Related U.S. Application Data
(60) Provisional application No. 63/110,547, filed on Nov. 6, 2020.

(51) Int. Cl. A47L 5/22; A47L 9/00; A47L 11/282; A47L 11/40; A47L 9/28; B25J 11/00

(52) U.S. Cl. CPC A47L 5/225; A47L 2201/024; A47L 9/009; A47L 11/282; A47L 11/4091; A47L 11/4072; A47L 9/2852; A47L 9/2894; A47L 11/4011; A47L 11/4066; A47L 11/4025; A47L 9/2857; B25J 11/0085; A47L 2201/04; A47L 2201/026; A47L 2201/028; A47L 9/0063

(57) ABSTRACT

Disclosed herein is the next step in cleaning evolution with my new Automatic Multi-Attachment Changing Station (AMACS). The AMACS System has three separate product lines that combine the best of all worlds, hands free, with computer touch screen integration.

### PRIORITY PATENT APPLICATION

This non-provisional patent application draws priority from U.S. provisional patent application Ser. No. 63/110,547; filed Nov. 6, 2020. This present non-provisional patent application draws priority from the referenced patent application. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2019-2021, Mark Jeffery GIARRITTA, All Rights Reserved.

### TECHNICAL FIELD

This patent application relates to cleaning systems, carpet shampooers, vacuums, floor buffers, canisters, and more specifically to an automatic multi-attachment changing station.

### BACKGROUND

It has been decades since any significant discoveries, or steps forward have been made in the floor cleaning industry, in the private or public sector. In the past, you have had Carpet Shampooers, Vacuums, Floor Buffers, Canisters and more, available to you for cleaning your home. Storing all of these Units is an inconvenience and takes up a tremendous amount of space. There is an option with the Kirby™ Homecare system, which has one Power Plant with numerous attachments that perform all of the above-mentioned applications. It can be inconvenient and cumbersome, to have to manually change through the various attachments by hand, to accomplish various cleaning tasks around the home.

### BRIEF DESCRIPTION OF THE DRAWINGS

The various embodiments are illustrated by way of example, and not by way of limitation, in the figures of the accompanying drawings in which:

FIGS. 1 through 29 illustrate the Automatic Multi-Attachment Changing Station (AMACS), the various components, and the operation of the AMACS in an example embodiment.

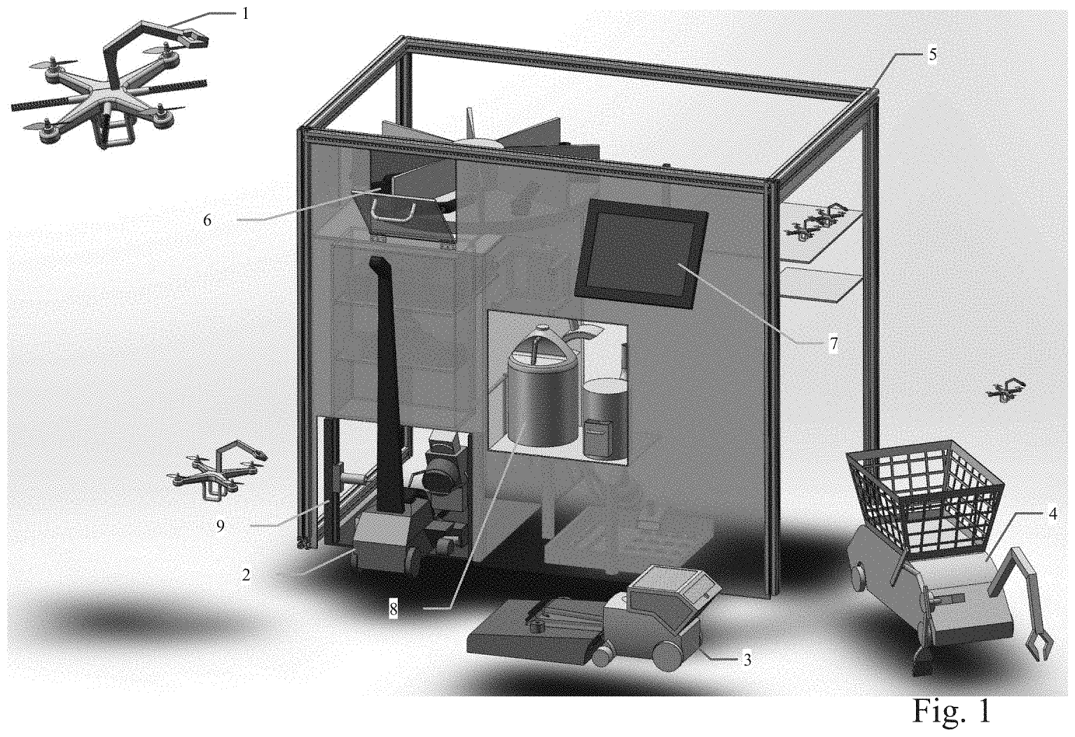

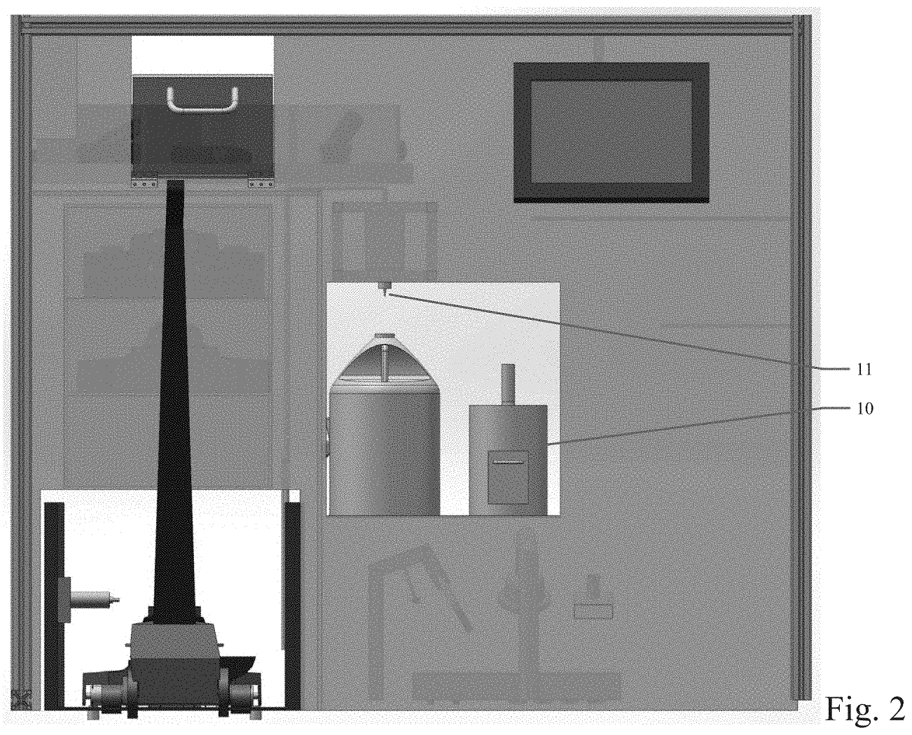

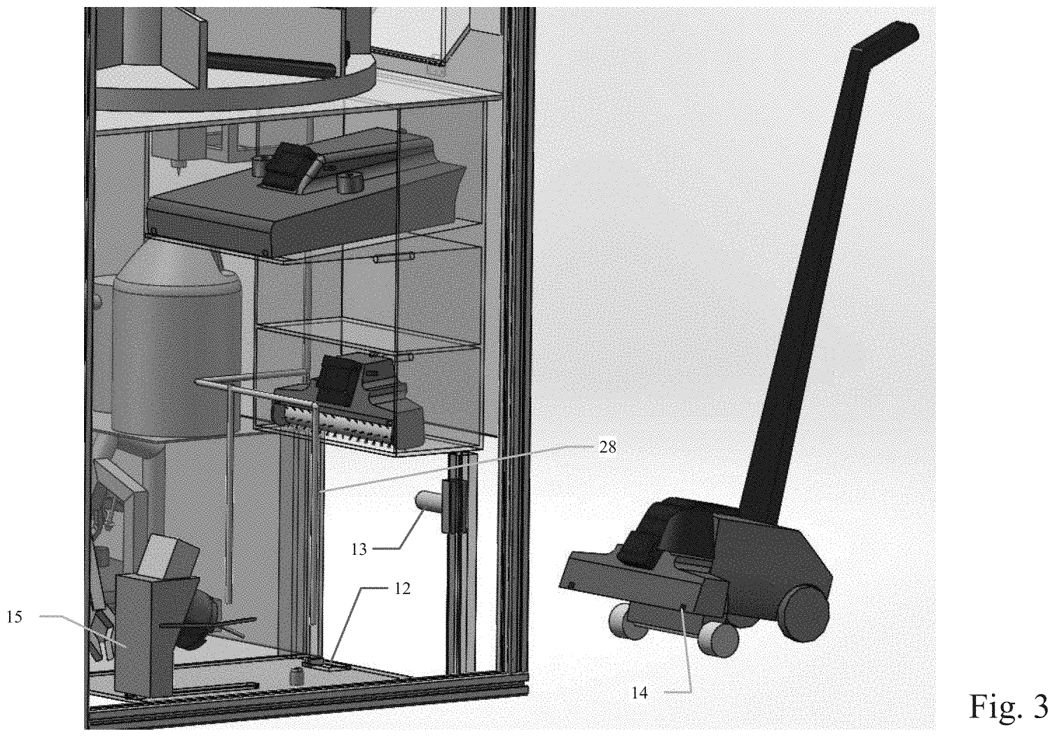

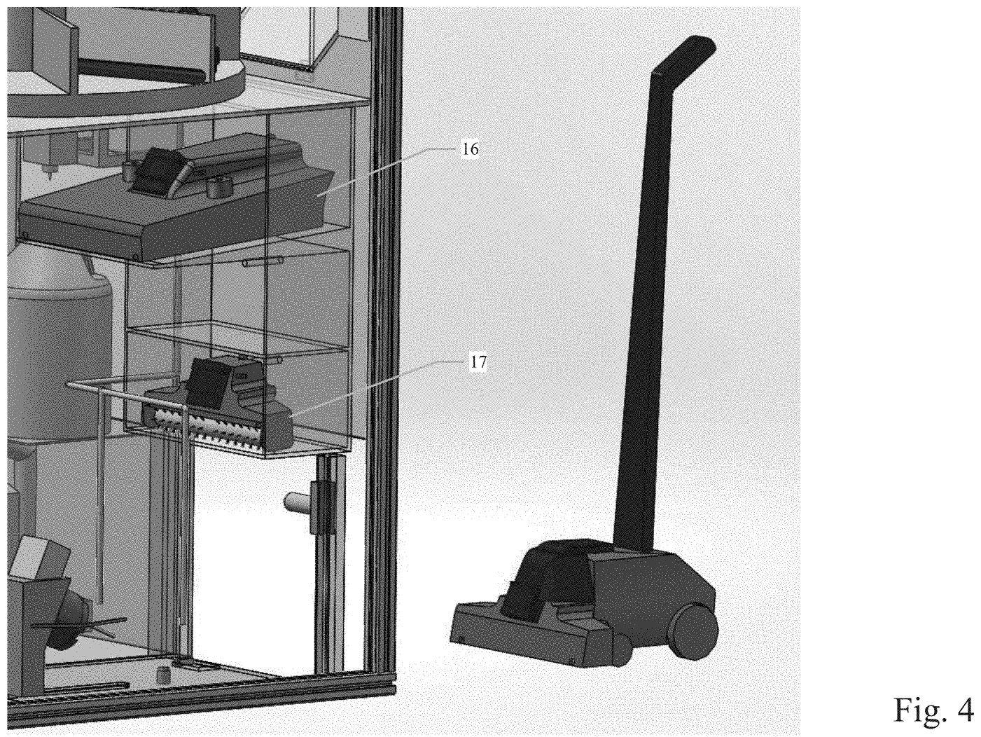

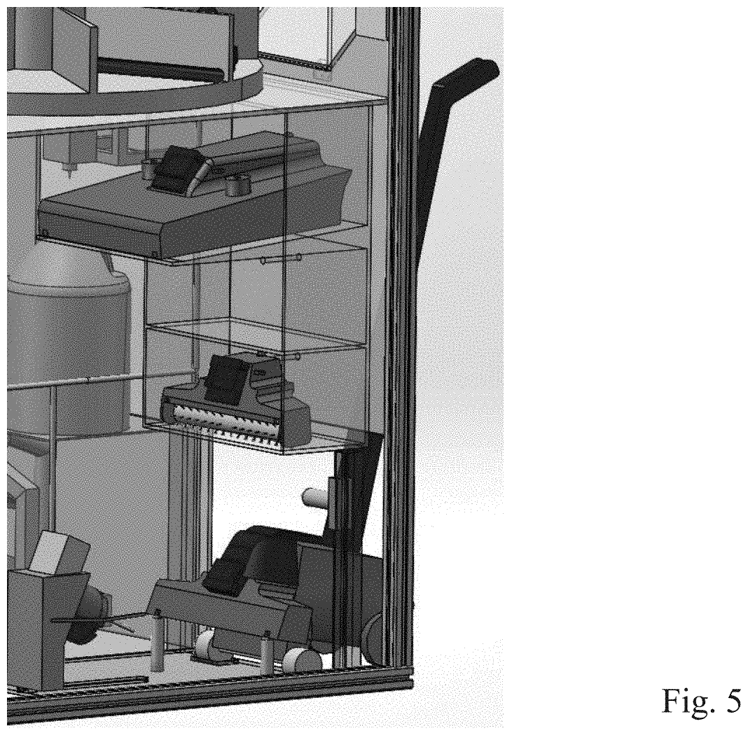

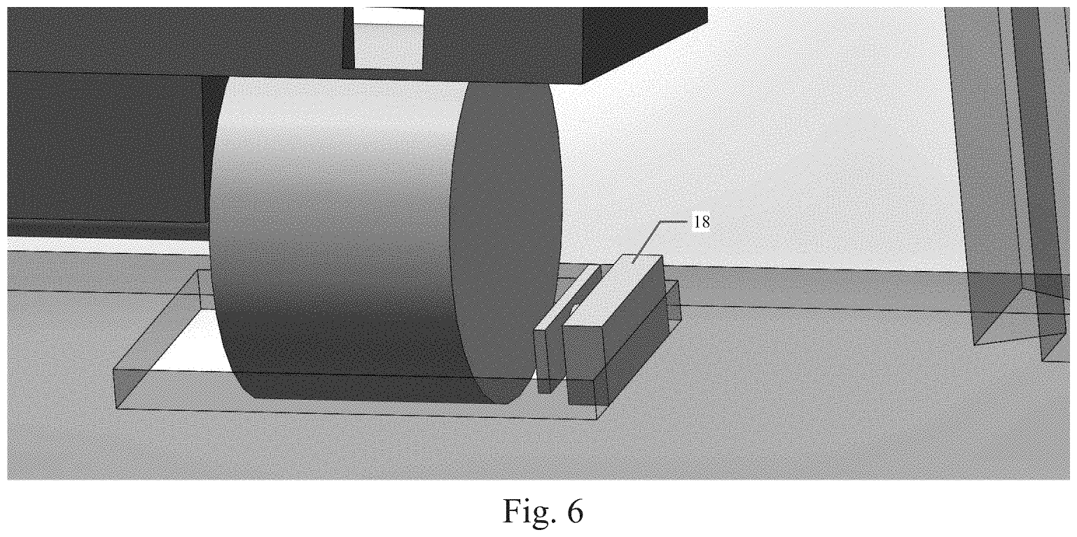

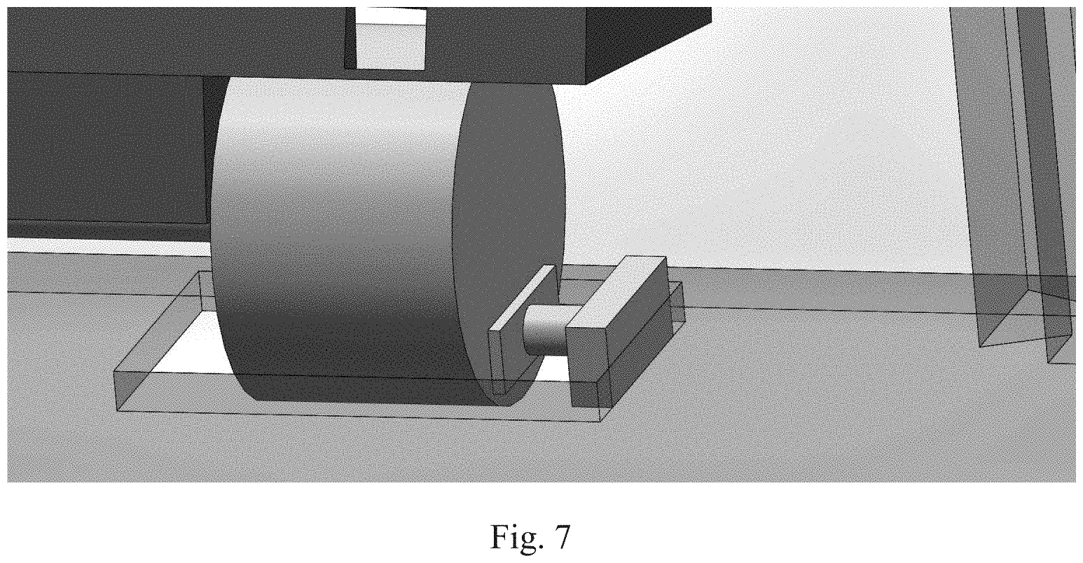

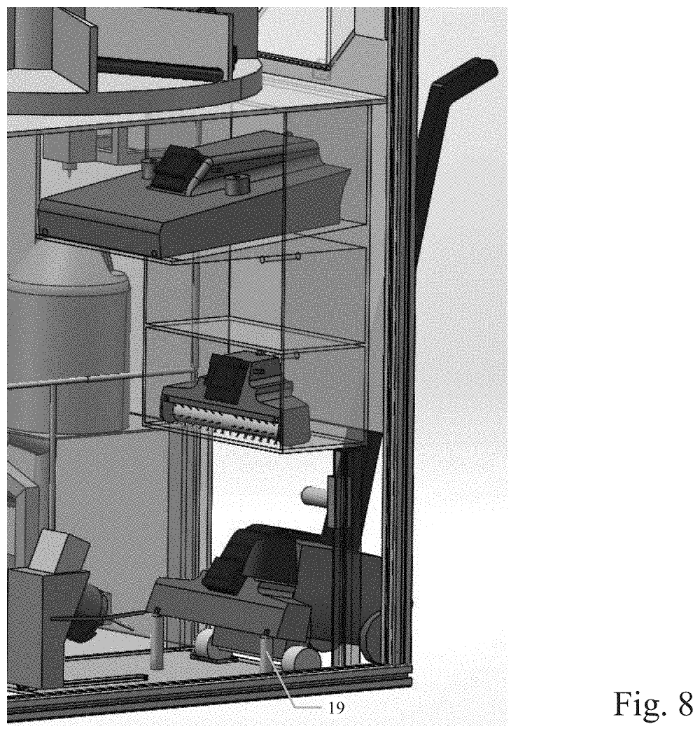

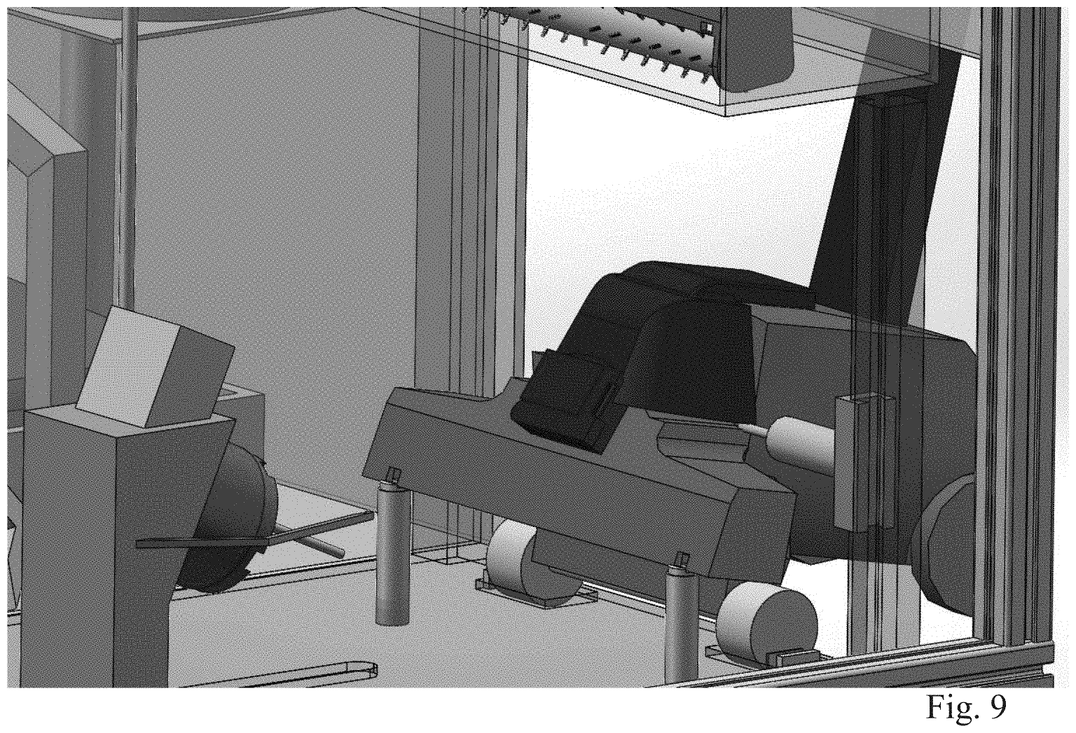

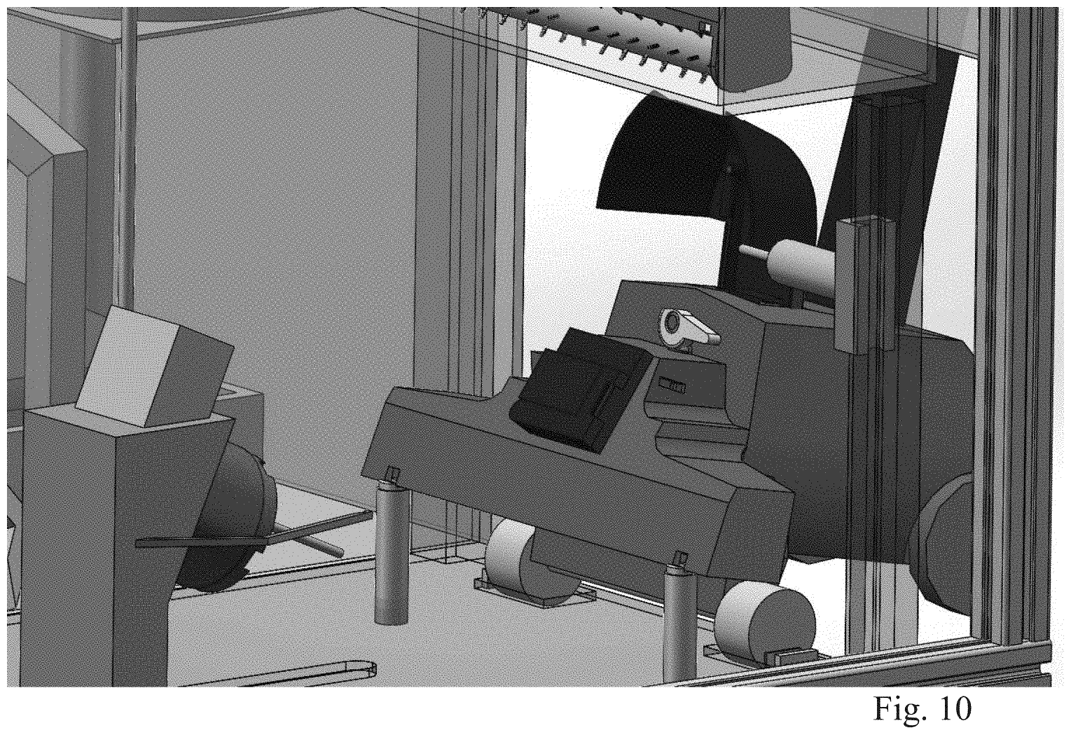

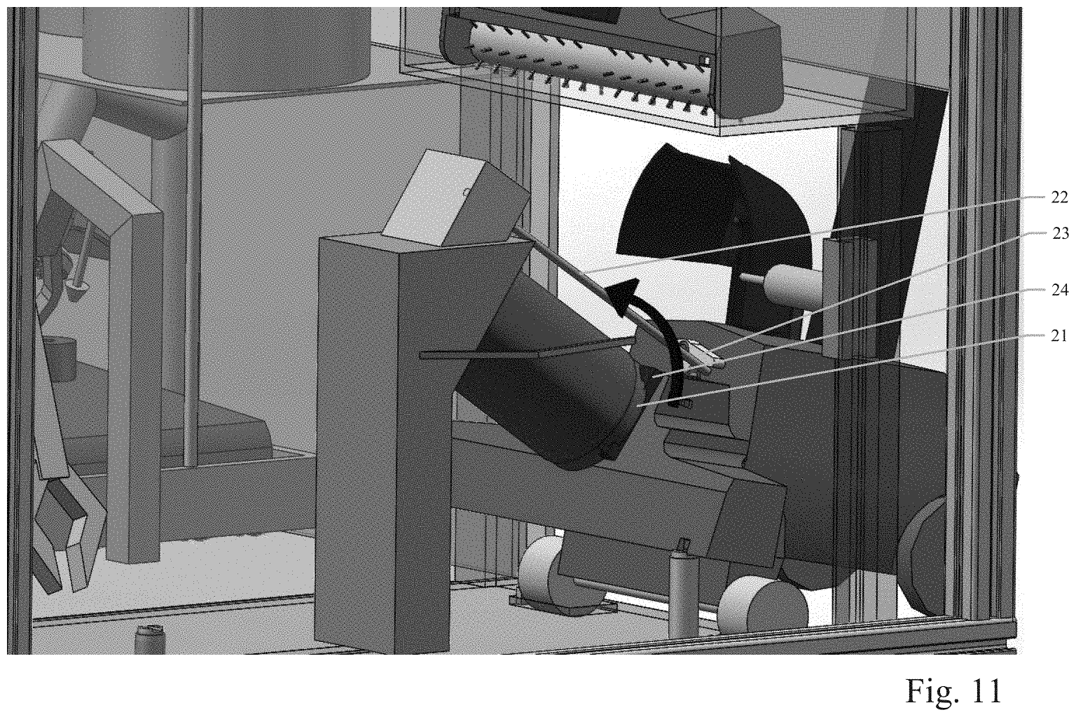

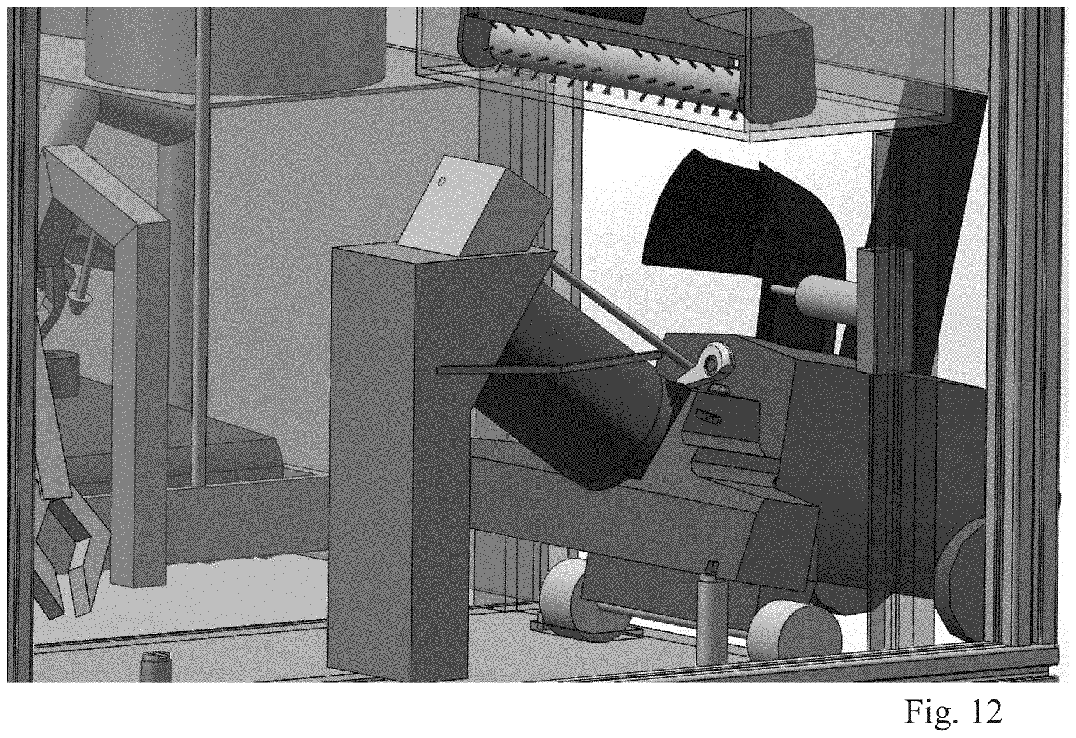

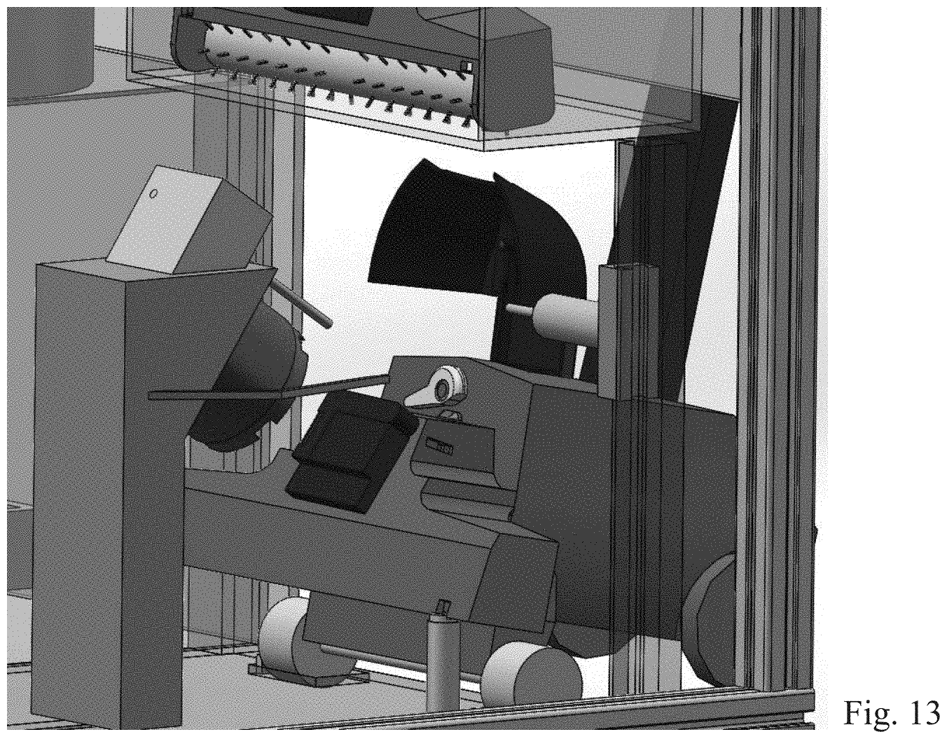

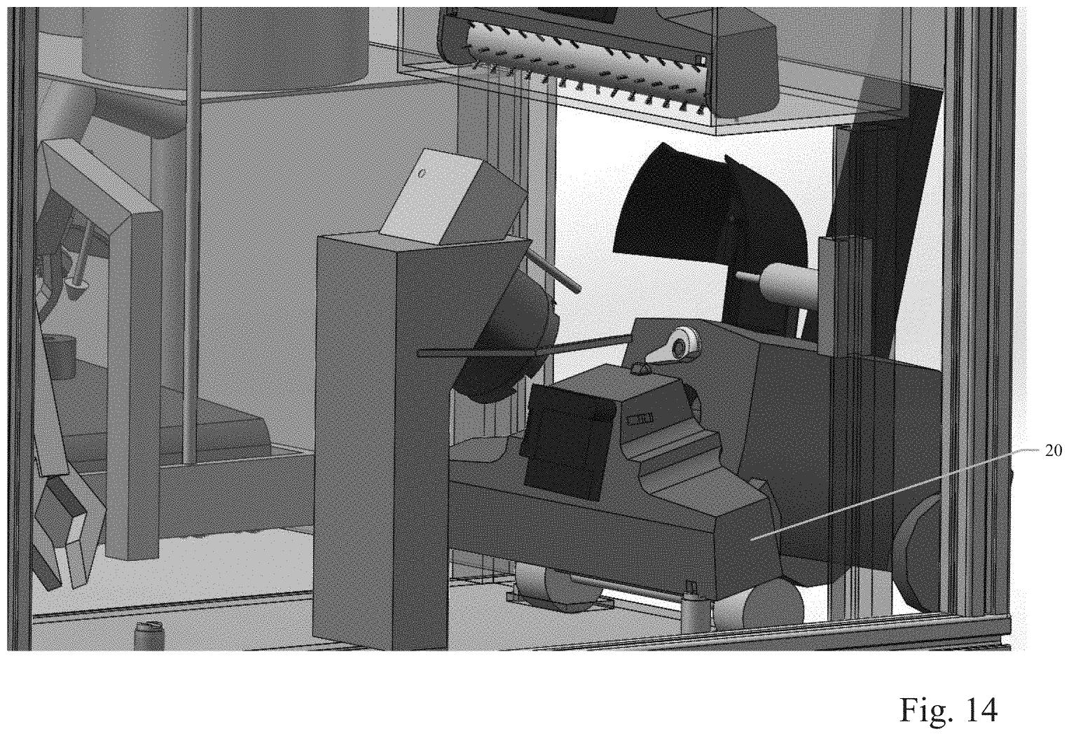

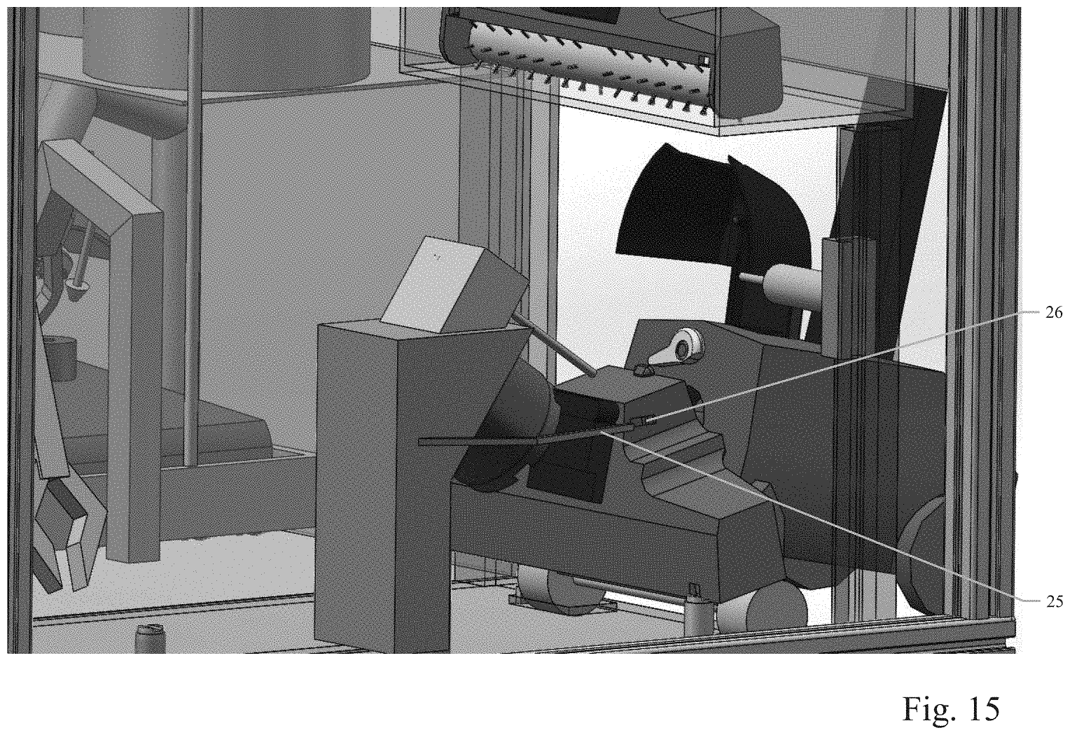

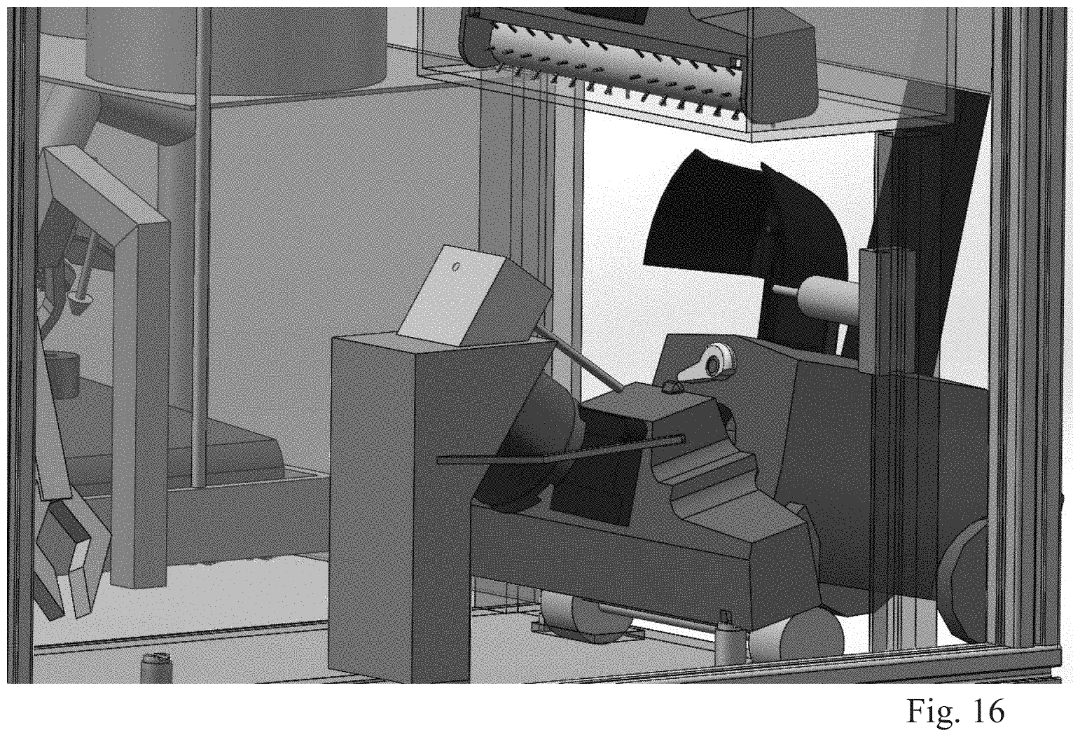

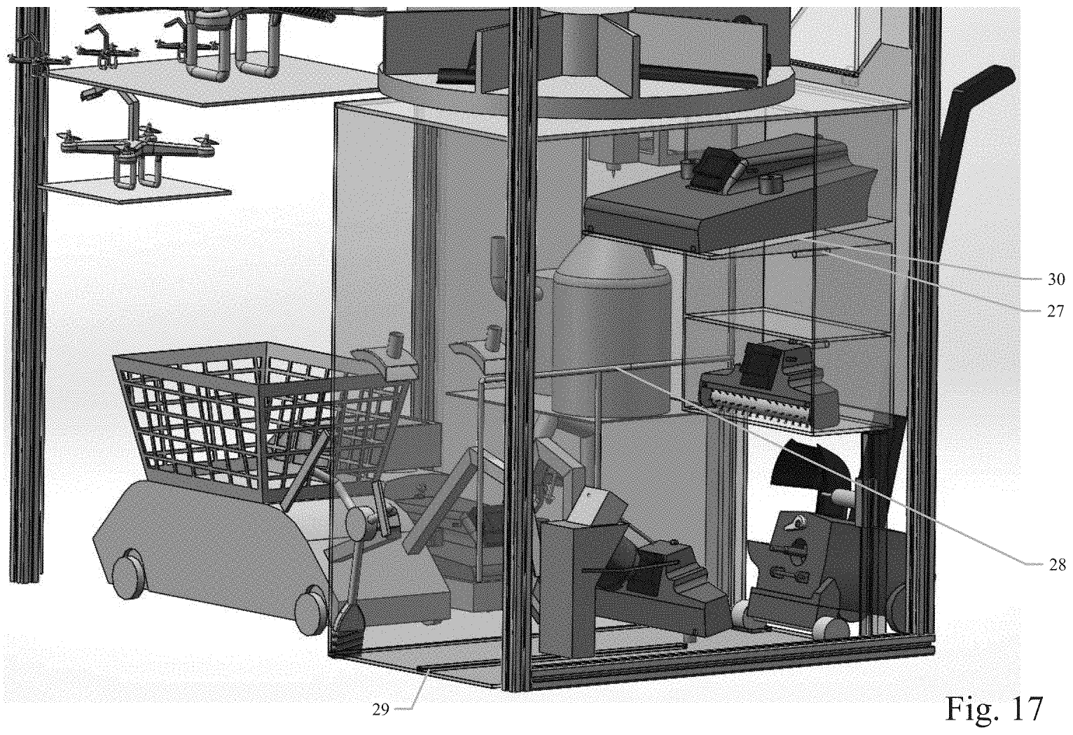

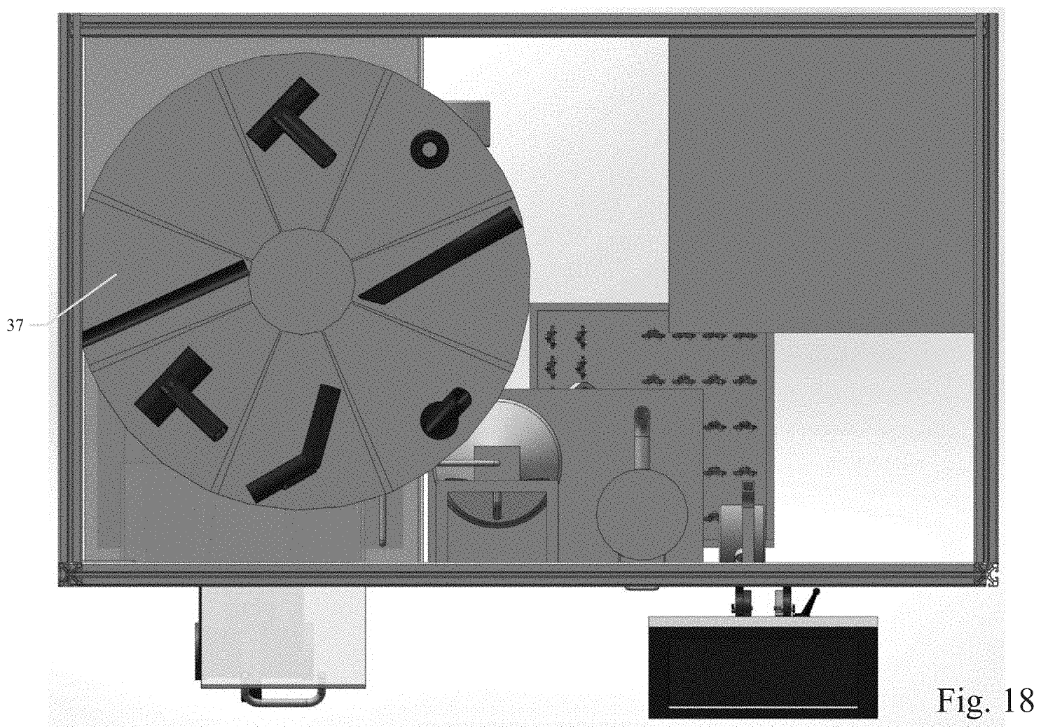

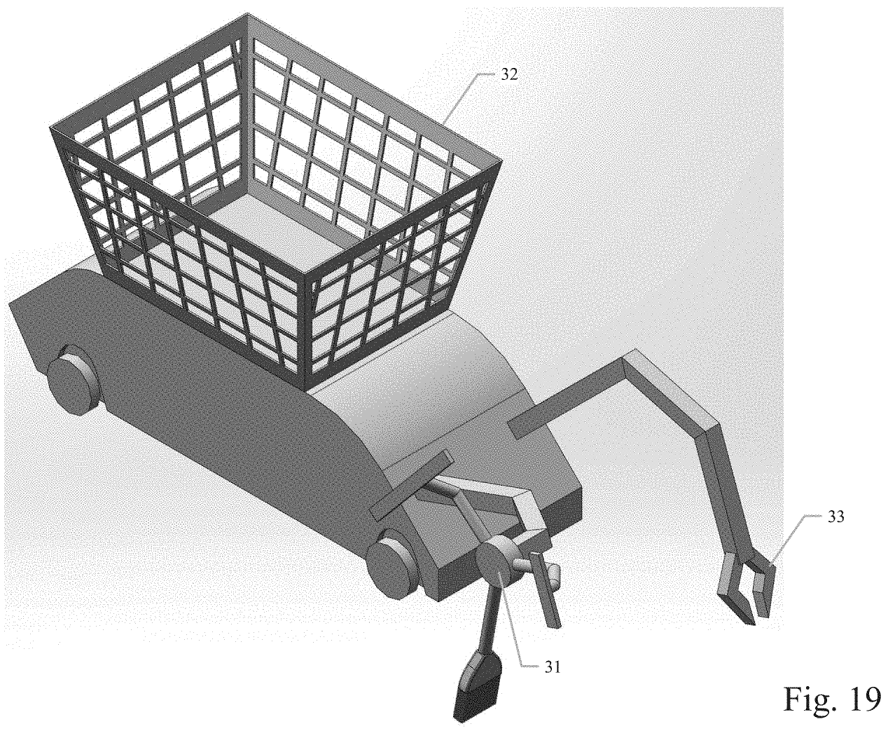

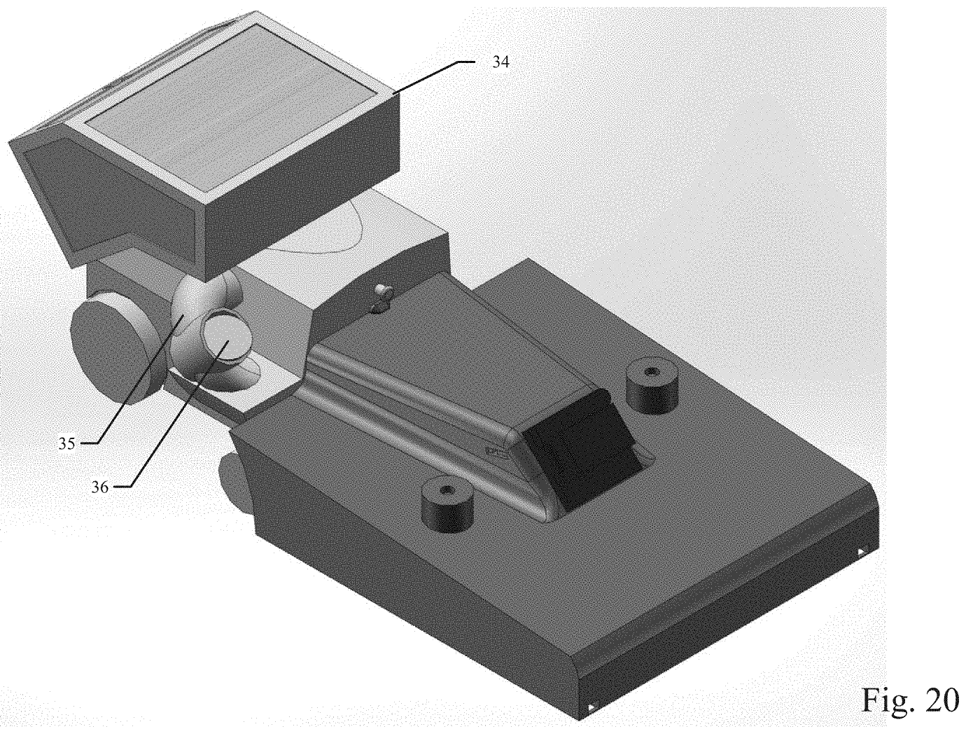

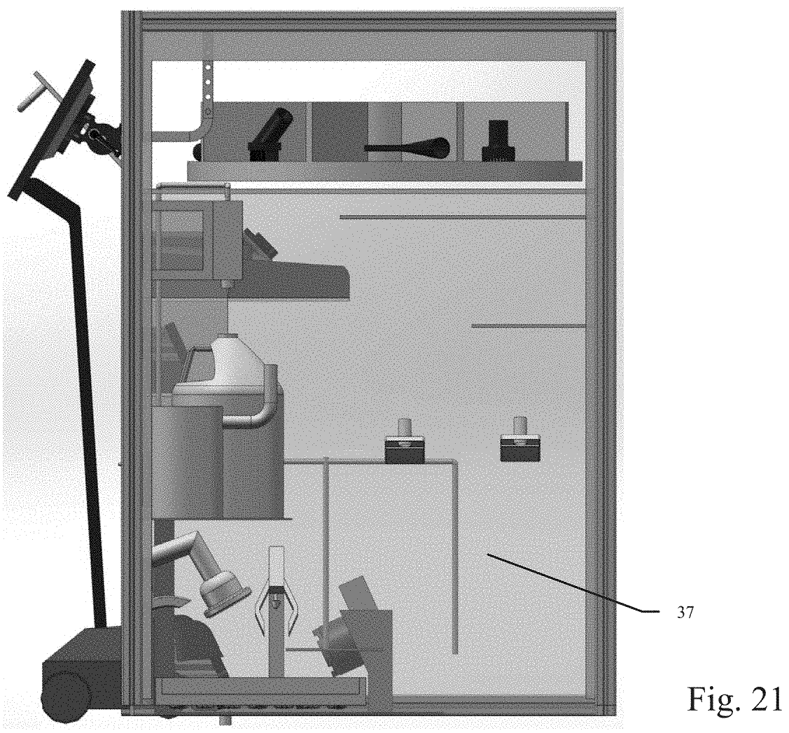

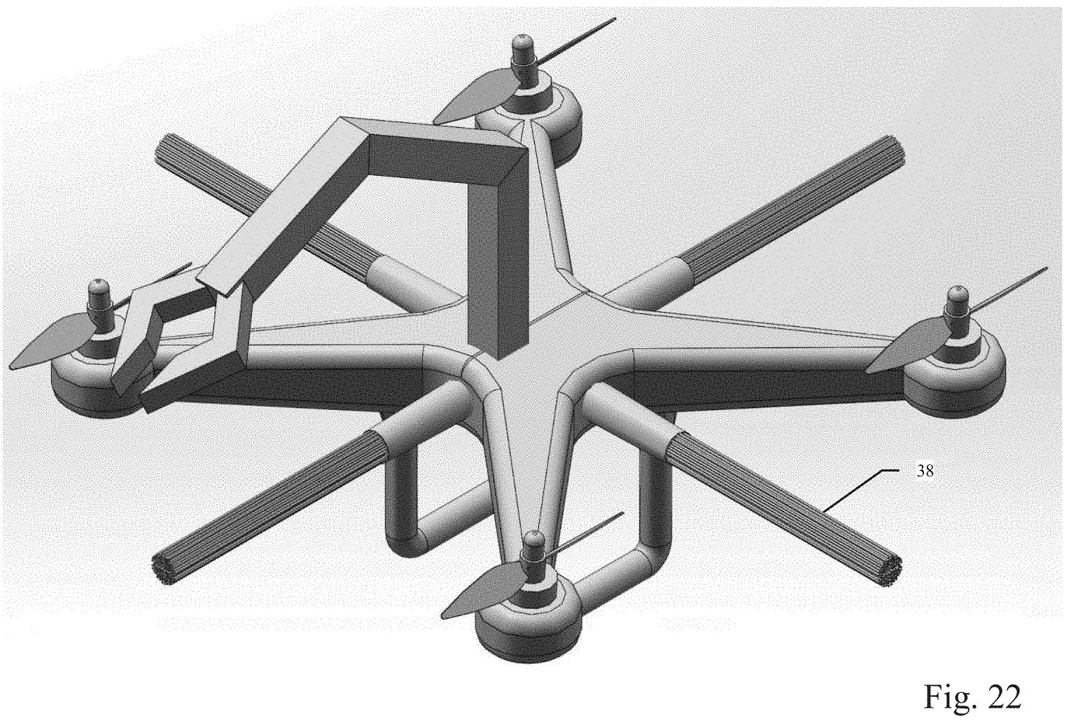

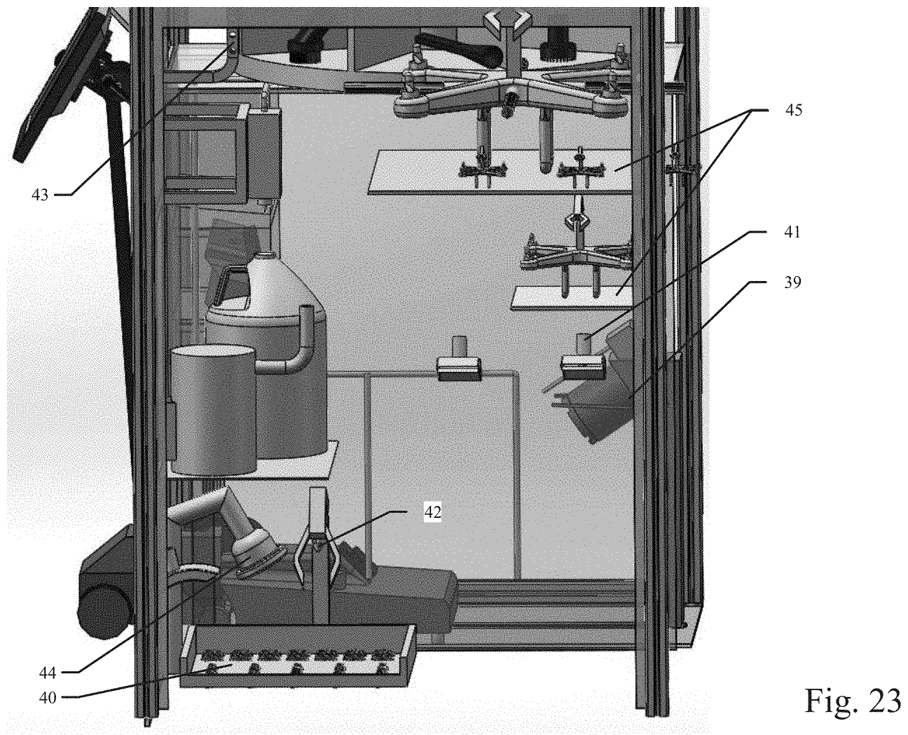

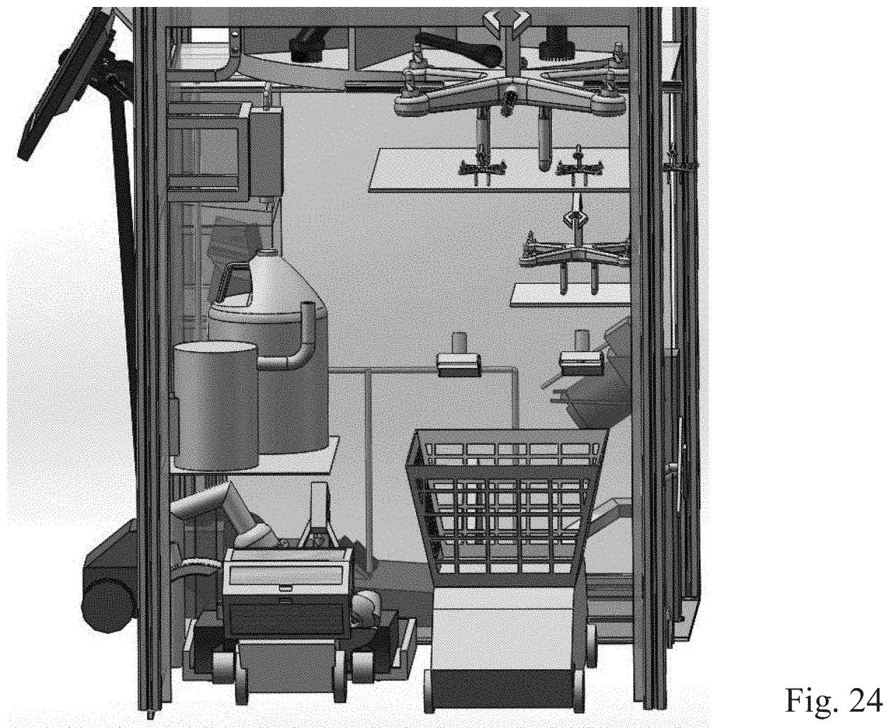

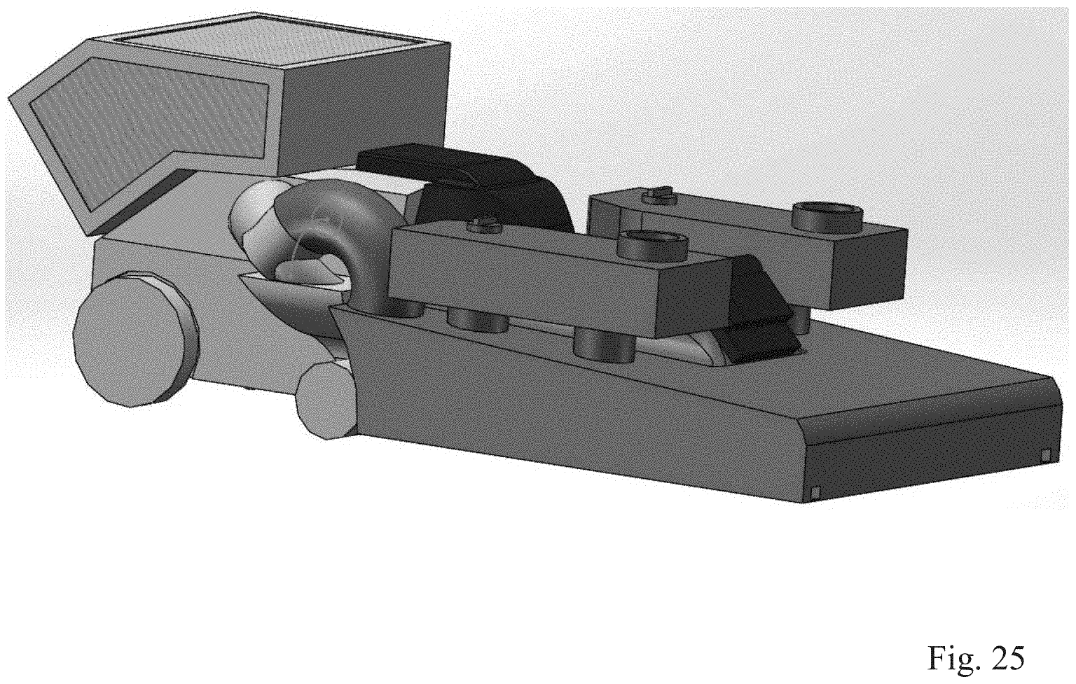

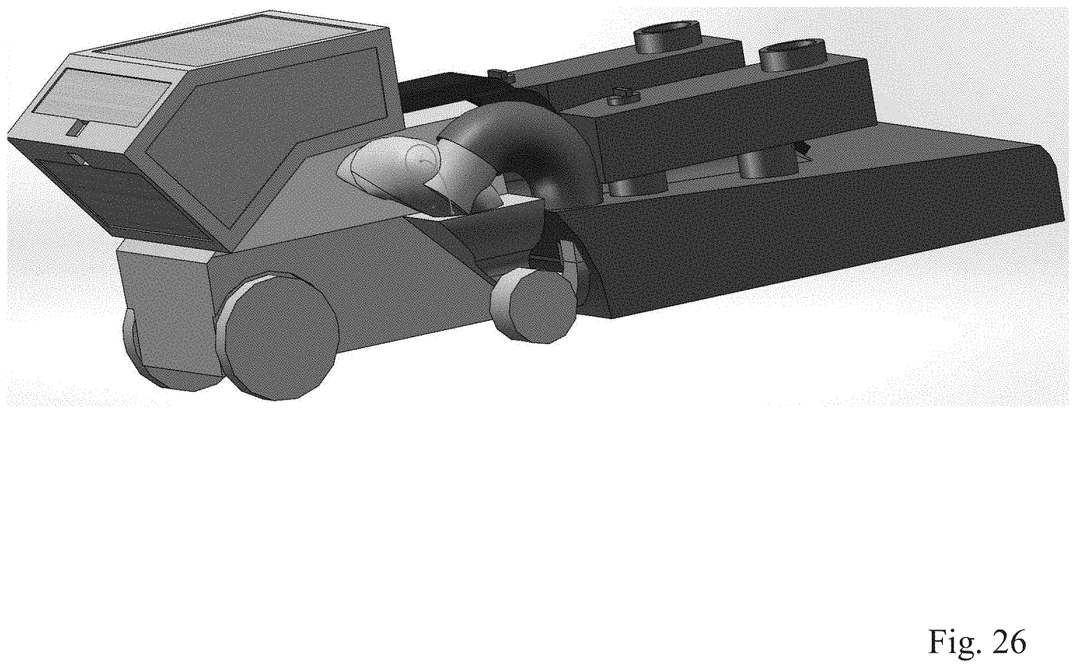

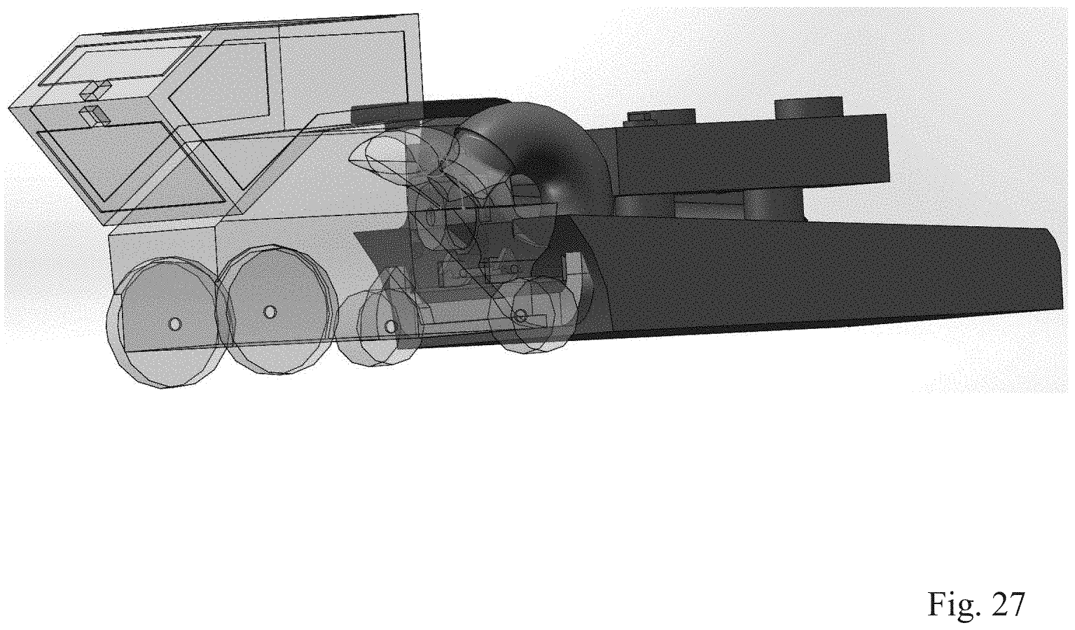

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

Disclosed herein is the next step in cleaning evolution with my new Automatic Multi-Attachment Changing Station (AMACS). The AMACS System has three separate product lines that combine the best of all worlds, hands free, with computer touch screen integration.

Portions of the AMACS System disclosed can use conventional technologies in the field of floor cleaning and all other fields necessary to make our new designs possible (e.g., plumbing, wiring, computer design with multiple core processors, etc.). Additional details for each of these product lines of example embodiments are described below.

### Product Line 1

### User Propelled System

The new AMACS Station Base (5), is a cabinet or in wall mounted system. It allows a user to use one Power Plant that can be driven into the Station's head changing portal or opening, on the front of the cabinet or in wall system, to have the Station automatically change from vacuum head, to Shampooer head, to floor buffer, etc. This action is controlled from an integrated touch screen that helps you navigate through the various attachments that are available for use.

### How Heads are Changed

1. The Cleaning Unit (2) will need to be driven up to the Attachment Head Changing Portal (9) using Highest height setting
2. When the Cleaning Unit is driven into the Portal, the front wheels drop into the Wheel Alignment Depression (12)
3. The Wheel Alignment Clamps (18), push up against the sides of the front wheels aligning and securing Power Plant for head change
4. The Tilting Pistons (19) raise up to the front of the attachment head, in this case Vacuum Head (20)
5. The Hood Lifter (13) lowers, extends to make contact and lifts the hood
6. The Head Changing Unit (15) moves forward and extends the Belt Lifter Turner (21) and the Attachment Lever Turner (22) into position
7. Belt lifter (24) is turned to release belt
8. Attachment lever (23) is turned to release attachment head
9. Turning instruments retract
10. Tilting Pistons lower attachment head
11. Attachment changing unit moves into position
12. The Attachment Grabbing Fingers (25) clamp onto the Attachment head in the Pick Points (26)
13. The Tilting Pistons lower
14. The Attachment Changing Unit moves back on its track (29) to position to raise up for attachment head delivery
15. The Attachment Changing Unit raises up to current attachment head's shelf
16. Grabbing Fingers extend to place attachment head on shelf, with the Attachment Peg (27) sliding into the suction port on back of Attachment Head, then release attachment head and retract
17. The Attachment Changing Unit raises or lowers to selected attachments shelf level, in this case Shampooer (16)
18. Grabbing Fingers extend and clamp into Attachment Pick Points
19. The Attachment Changing Unit moves back on its track, to position for lowering attachment head back down
20. In the case of Shampooer in this design, the shelf retracts (30) to make room for Shampooer head to be lowered
21. The Attachment Changing Unit lowers to Cleaning Units (2) level for attachment head placement
22. The Attachment Changing Unit moves forward on the track to put Shampooer head in position for re-attachment, placing Attachment Hooks onto Attachment Bar
23. Tilting Pistons raise up to bottom, front of shampooer, in position to support the attachment for Grabbing Finger release, (The Tilting Pistons Attachment Cutouts, (14) help let the Pistons tilt the Attachment Heads up and down unobstructed.)
24. Tilting Pistons raise Shampooer into position for reattachment
25. The Attachment Changing Unit moves into position and extends Attachment Lever Turner into position and turns Attachment Lever into locked position
26. The Attachment Lever Turner is retracted and the Belt Lifter Turner is extended into position
27. The Belt lifter Turner turns Belt lifter to lower belt back onto output shaft of Cleaning Unit, (Shampooer doesn't require this step, because the belt of the shampooer head is connected inside shampooer head and doesn't connect to Cleaning Unit)
28. Hood is Lowered
29. The Hood Lifter Retracts
30. Tilting Pistons Lower
31. Wheel Alignment Clamps release
32. Cleaning Unit is reversed out of Head Changing Portal
33. Cleaning unit is lowered and off you go
34. (This section is for Shampooer only) The Attachment Changing Unit moves back down its track, to make room for Shampooer to be lowered and Cleaning unit is lowered to fill with shampoo (The filling process could possibly be completed in up position, but it could be difficult to fill tanks completely due to angle)
35. Soap filler tubes (28) swing into filling position, lowers into filling position or squirts in soap from a stationary predesigned fill position and soap tanks are filled
36. Fill tubes move out of way
37. The Wheel Alignment Clamps release
38. The Cleaning Unit is reversed out of Head Changing Portal and you're off to clean

Each hose and head attachment should have some sort of electric or microchip tag device, so that the AMACS Base can identify which attachment is being inserted. This way the AMACS Base doesn't have to have a different specific slot for each attachment. There may be one exception to this. Since the shampooer is so long, it may require its own shelf.

In the case of the Shampooer, the AMACS Base unit can also be set up to remove waste water through the shampooing process, along with filling the soap reservoirs and cleaning the Shampooer, automatically hands free in the Shampooer Cleaning Station (40). The waste water could be pumped to a push button removable tank for easy emptying, or for nearly hands-free operation, the Base can be plumbed directly into the houses water and sewer systems, for automatic water distribution.

In the case of the Vacuum attachment, it could be possible to have the AMACS Base suck the dirt back out of the bag periodically to extend the bag life, or have the dirt go into a canister type tank that the Base can also suck the dirt out of and deposit into a garbage bag, a removable tank or directly into your garbage can with a transfer system. (not illustrated)

For Canister Attachments, we again go to our Touch Screen, to select the Canister Attachment needed for the current cleaning task. The AMACS Base then brings the Touch Screen selected Attachment up to the upper Canister Attachment Portal (6), via a carousel (37), lazy susan, ferris wheel, robotic arm or alternate cycling device. You now open the door or just reach into the portal if no door, grab the needed Attachment and off you go. Once you're done or need another Attachment, just deposit current Attachment back into the Portal, select next Attachment, let our Base bring it up and away you go!

As an added bonus, the AMACS Base can come with a built-in stereo, Bluetooth capable and have the various Docking Port in current use (not illustrated) for musically-inclined cleaners. This brings all the advantages and ease of the 21^{st} century to your fingertips!

### Product Line 2

### Robotic Home Use

Please welcome this most exciting new Robotic product line made possible by the discovery of the AMACS System. Once the System can change the different cleaning heads on and off on its own, fill up soap and empty waste water for shampooing, the next step is making it fully automated and Robotic.

The Home Robotic series will have a few new attributes from the User Propelled model:
1. The Cleaning Units Power Plant and various Bots, will be Battery powered, Computerized, Robotic and self-operating, or drone style controlled by the AMACS Base Station
2. It will have a (RHBPS) guidance system/module or Robotic Home Base Positioning System, to guide the unit. It's like GPS, but using the AMACS Base for a positioning signal instead of a satellite
3. Flight Drone (1) assistance for scanning, dusting and cleaning of elevated areas and surfaces such as: Cleaning cobwebs from corners and around the ceiling, dusting furniture, blinds, knickknacks and walls, etc.
4. A Laundry/Maintenance or LM bot, which is an extra robot unit that is able to pick up objects (e.g., clothing, toys and trash), before the Cleaning unit vacuums or shampoos, etc. Also, the LM bot can push in chairs and or move around furniture or obstructions, if necessary.
5. Cell phone App integration, to help guild, check progress or give cleaning commands to the cleaning system while you're out of the house
6. Onboard Camera for visual tracking
7. The vacuum can have a bag less style receptacle that the LM bot can remove and empty
8. Cleaning Cycles can be preprogrammed and set up on daily schedules, so cleaning happens constantly and automatically, with little or no need of user assistance

The AMACS Robotic concept could also be less space efficiently achieved by having a station that had a separate Robotic Cleaning Unit for each previously mentioned cleaning process; vacuuming, floor buffing, shampooing, etc. Also, it could be possible to make a machine that could do all needed processes all together in one machine, although it would probably be too bulky for most applications.

### How it Works

To thoroughly clean your home, it will take more than a machine aimlessly wandering around. This is why during installation of the Robotic AMACS Base, the Guidance System needs to be set up. The new Robotic Home Base Positioning System, or (RHBPS) Guidance System, has a digital blueprint of the building input into the system. Since nearly all construction blueprints are made with a digital copy these days the schematics are readily available. For older homes, pre digital blueprint, a set will have to be made.

Once blueprints of the home, facility or landscape are input into the AMACS Bases data bank, the system's Microprocessor/Computer uses the AMACS Base as the positioning reference point instead of satellites. Using the positioning signal of the Base, the feet and inches measurements of the blueprints, the location signal of the particular bot, 2 more sensors placed in the home, facility or landscape for Trilateration, the central processor of the AMACS Base, mathematically and dimensionally plots, a predetermined, computer generated work order for the cleaning bots to follow. As the Cleaning Unit, LM Bot drives away from the AMACS Base, using the positioning signal of the Base combined with their location signal, the additional trilateration sensors, the odometer and sensor readings of the unit, and laser distance sensors, the computer of the AMACS Base and or Cleaning Unit or LM Bot, carefully and precisely guides our Robotic Units through the home facility or landscape in a grid-like fashion as a human would do to complete the work order. In larger buildings or installations, signal boosters may be required, especially in concrete and steel structures where the location signals may be weakened from the materials the walls are made of Drones will be guided in a similar fashion, using the AMACS bases mapping and positioning signals along with the Flight Drone's sensors. The Flight Drones will require extra sensors on the top and bottom to do additional vertical navigation.

### How the AMACS Base is Set Up and Learns its Position on the Digital Blueprint

At initial installation of an in wall mounted Base or a movable cabinet style AMACS Base, through the touch screen (7) or phone app, the AMACS system will ask you to show it which room it is in on the Digital Blueprint. Once you select the appropriate room, the AMACS Base scans the room, (not illustrated.) This can be done with a variety of sensors, (sonar, LIDAR, extendable measuring rods, RF sensor, etc.), but laser distance readers in all directions should be sufficient to dimensionally determine its position in the room. Objects may need to be moved making a clear path to walls, in the path of the laser measurement sensors for an accurate reading. Once the AMACS Base has scanned its dimensional position in the room, the Flight Drones are deployed to do a scan to make sure the right room is selected. Selecting the wrong room would throw off navigation, with scanned layout relative to the AMACS Base not lining up with the digital blueprint.

If you accidentally select a room other than the one the AMACS Base is actually in, the AMACS Base will notify you of the wrong selection and work with you through the setup process, until the right room is selected and the dimensions of the blueprints and scans line up.

Additionally, for wall mounted units, their position in the home or facility could be input directly onto the blueprint, so that the initial placement scan isn't necessary. For both applications, Flight Drones, Cleaning Units and LM Bots will constantly be scanning the accuracy of all dimensionality, to update the blueprint, in case initial AMACS Base setup is slightly off and to account for imperfections in the building process such as, the building having portions that are out of square. The AMACS Base will continue intense scanning and alterations of the blueprints, until the digital blueprints match the existing conditions exactly. This is all done to ensure cleaning duties are performed as thoroughly as possible.

In the case of outdoor landscapes, the AMACS Base's location and location of trilateration sensors may need to be established with surveying or possibly a direct link to satellite positioning. Their locations will need to be input directly into the digital blueprint manually or computerized for Guidance System setup since the AMACS Bases won't be able to measure its own location very easily from its surroundings.

Now, once the AMACS Base has its location nailed down, the onboard Computer can plot work orders and navigate a Cleaning Unit or Units, The LM Bot or Bots and Flight Drones through the day to day cleaning tasks. The cleaning bots may require a built-in compass, along with other sensors such as; bump sensors, odometer, LIDAR, sonar, sonic, RF, infrared, etc., to help with positioning, keeping to the work order and making maneuvers such as; turning around at the end of a room while shampooing or vacuuming. This is important for completing work orders and not getting off the cleaning path in a way that a portion of a surface to be cleaned is missed.

In addition to guidance, the Flight Drone and bot scans add to the digital blueprints of the home, building or facility, a 3d representation of the workplace, which is necessary for operation of Flight Drones. Also, the blueprints data can supply all the different surface types around the work site: various flooring types, wall type and finish texture, ceiling type and finish texture whether they be wood, metal, concrete, stucco or textured sheetrock. This helps determine the cleaning process needed for each surface. In addition, furniture and home décor can be scanned for shape, dimensions, color, density and material type, with scanning devices/sensors to determine material compositions and cleaning methods necessary. This is especially necessary, to determine if something is for instance, fragile or breakable, to know how to best clean it or not to clean at all. Also, at initial installation objects that are determined 100% uncleanable by the AMACS System, can be input into the system as do not touch.

Knowing the size of objects is necessary for plotting accurate work orders. To aid this process, Microchips that can be sensed by the on bored sensing apparatuses, can be placed on objects to for instance, not clean or just identify. When home décor is moved from place to place, it is immediately recognized by the system. Once chip is placed on object, a manual scanner could be used that takes down all of the item's dimensions and info, to upload info to chip. Alternatively, either a manual scanner or the bots can scan items and use a combination of a camera and the internet to find item make and model, to come up with item schematics to be uploaded to its chip. This can also be helpful to identify no clean orders and objects such as children's toys that could be loosely scattered and mistaken for trash.

Additionally, the AMACS System can store local site information such as: various home décor, its dimensions and location, cleaning paths taken, stains that were cleaned, places that were not able to be cleaned that need a go back, etc. Logging this information could be useful for the AMACS Computer to learn to be more efficient and make sure that no area is missed in the cleaning process.

Before the Cleaning Unit is deployed, the Drones take flight and scan the home or facility, to notate current positioning of furniture. The system can save it to the blueprint and use this info to plot an accurate work order to clean the home. The Drones scans and later scans from the Cleaning Unit and LM Bot, can be used to determine cleanliness of surrounding surfaces to be cleaned and after cleaning, to make sure all foreign substances have been cleaned off of flooring, walls, furniture, décor or ceilings, etc.

Once scanning is finished and the work order is complete, the LM Bot is deployed to pick up scattered laundry and deposit it in the washer area (or directly into washing machine for automated laundry service), pick up toys and deposit them in the children's area and pick up and dispose of garbage. Lastly, the LM Bot will push in chairs if needed and or readjust furniture necessary for the cleaning unit to operate. The Flight Drones, LM Bot and Cleaning Units will have onboard cameras, so for instance; if the LM Bot comes to an object that it doesn't recognize as good or garbage, the LM Bot can send messages to you on your phone app to ask what the item is. You look at the item on you display and instruct the LM Bot to either keep and deposit the item in a predetermined area for you to pick up when you get home or its garbage and it throws it away. The system could also be set to not bother you and just deposit unknown items in a predetermined area you preset or input from app. The AMACS Base can keep a data bank of known items, for quick recognition and good or garbage categorization.

Once the LM Bot Completes its Cleaning tasks, the Cleaning Unit Deploys to vacuum first and Shampoo next, to clean any soiled areas the system determined in need of attention though the scanning process, (LM Bot, Cleaning Unit and Flight Drones can work simultaneously). Also, say you have a guest coming over for dinner and you're not sure if the living room is clean. No problem, just pull up your app, go into the select area to clean option that pulls up the blueprint of your house, touch the living room on the screen. It will ask what you want it to do, select shampoo and away it goes. The Cleaning Unit is sent out, it vacuums and then shampoos. Viola, perfectly clean living room when guests show up! The Cleaning Unit could also shampoo just a spill if the carpet is pretty clean and just 1 or more spills are present. Additionally, the Cleaning Unit could be equipped with a spraying apparatus that can spray stain remover, pre shampooing and during shampooing if needed.

Additionally, Cleaning Unit could spray oils for buffing if needed and or disburse powders if necessary. Simultaneously, with the LM Bot and the Cleaning Unit working, your Drones take flight to dust and remove cobwebs around the home.

Hardwood floors and tile homes. In this case, preventing damage to your wood floors has never been easier. With the ability to schedule your Robotic AMACS system to clean and buff daily with the Buffer Attachment (17), abrasive grit and grime buildup are taken out of the equation. In tile homes, with the same ability to program daily buffing, cleaning and shampooing, your grout lines never need be dirty again!

In Homes that have multiple levels, it may be necessary to install a transferring apparatus. There are a few ways this can be accomplished: a wheelchair style lift in the stairway, to move the Cleaning Unit and LM Bot from floor to floor. A mini elevator or dumb waiter that could also lift the Cleaning Unit and LM Bot up and down stairs, or use Drone flight to move Cleaning Units and LM Bots from floor to floor.

It could be possible for the AMACS Base to employ multiple Cleaning Units and or Multiple LM Bots with a corresponding number of attachments inside, to clean 1 home, building or facility. All AMACS Bases will generally have multiple Flight Drones of varying sizes, unless a customer or application calls for them not to be used. It could also be possible to have multiple AMACS Bases with Multiple Cleaning Units and LM Bots, working together to clean 1 home, building or facility, especially in a multi-floor/level application.

Alternatively, the user operated AMACS Base, can also employ the use of Robotic Flight Drones and LM Bots for the cleaning process. For full home automation, computerization and communications means, etc. can be added to all home appliances: Washer and dryer, dish washer, oven etc., so that they can be controlled by the AMACS Base, to allow our System and Bots to operate these appliances and fully automate the remaining cleaning and possibly even cooking tasks not already fully described. Bots that complete different tasks from the Cleaning Unit, LM Bot, and Flight Drones can be added to this AMACS system to expand Cleaning or Other capabilities.

### Robotic Cleaning Unit Drive Control and General Design/Function Parameters

Our Robotic Cleaning Unit (3) employs the teachings of all prior robotic, floor, home or facility cleaning art, along with the prior art of any field necessary to make our designs and concepts possible. This invention employs a Robotic Cleaning Unit which is capable of cleaning while moving on a floor, under the control of a microprocessor/computer on board the Cleaning Unit, or remotely controlled as a drone by the AMACS Base. The Cleaning Unit, LM Bot, Flight Drones and AMACS Base could employ AI learning to the extent that the Bots can communicate with each other and the AMACS Base to clean better and more efficiently.

The Robotic Cleaning Unit is battery powered and able to self-charge, by directly or wirelessly connecting to the AMACS Base, or a designated charging station or stations throughout the home or facility. Additionally, all of our Cleaning Units LM Bots, and Flight Drones, can employ onboard charging apparatuses resembling the alternator of a car, turbine of a windmill water/hydraulic fluid motion generator, solar panels or some yet undiscovered charging method, to eventually not need charging and possibly not need batteries.

The Cleaning Unit is a surface treatment robot that includes a chassis, having front and rear ends and a drive system carried by the chassis. The drive system includes, right and left driven wheels and is configured to maneuver the robot over a cleaning surface. The drive system is under the control of the microprocessor/computer, in order to cause the Robot Cleaning Unit to be moved forward, backward and turned left and right or rotate completely in place to change direction or for cleaning processes. It will incorporate sensors that scan its surroundings and cleanliness of the surfaces to be cleaned. It will have a transmission sending and receiving means, to communicate with the AMACS Base Station and the other Bots. In this manor, the Robotic Cleaning Unit is able to send, receive, and compute the computer generated, pre plotted work orders of the AMACS Base. The Work Orders are based on the cleansing needs, orientation of furniture, home décor and room layouts.

Cleaning is done more efficiently than ever before with our new RHBPS Guidance System, using pinpoint accuracy to navigate the work order around the home or facility, most likely cleaning in a grid like fashion just like a human would. Alternatively, it could be possible to less efficiently clean the home or facility using standard industry navigation systems or a system not disclosed.

The new Cleaning Unit has various components that incorporate, connect and disconnect, so it may perform the various cleaning tasks associated with its attachments, (vacuum head and dust receptacle (34) or cup, floor buffer, shampooer, etc.) The Cleaning Unit has a height adjuster that can be manually and computer operated. Although the Cleaning Unit is Robotic and Automated, it also has a manual mode for use of the canister set up and the various other process attachments. This is necessary if the need arises for canister cleaning inside or outside of the home, (vacuuming the car) or manually buffing, vacuuming or shampooing at a friend's home or someone's work place, for example. For the manual canister mode, the use of a tethering device could be employed. User could wear a bracelet or device that emits a signal for the Cleaning Unit to fallow. This way, as you manually canister clean in an area, the Cleaning Unit fallows the user at a predetermined distance. This will allow you to still reap the benefits of the Robotic Cleaning Units drive system, so you don't have to drag the Cleaning Unit around. The bracelet could also have command controls on it. The tethering device could also be used for other manual use applications and or with the user propelled model and the Cleaning Unit only model that doesn't use the AMACS Base. The Cleaning Unit could be constructed of various materials such as; metal, wood, plastic, composite materials, or other.

### Laundry/Maintenance Bot or LM Bot Drive Control and General Design Parameters

The LM Bot (4) will be controlled, directed, operated, charged and constructed in a similar fashion as the Cleaning Unit. The LM Bot will employ a minimum of 1 robotic arm, but will probably have 2 or more. At the end of an arm, will be a robotic hand or grabbing device, for picking up laundry, adjusting furniture and picking up trash too large to vacuum, etc. A second arm would have a sweeping implement at the end of the arm, to sweep up smaller garbage or rocks that wouldn't vacuum.

The LM Bot should have a receptacle on its back that it can deposit laundry, toys, garbage, etc. into, for removal from cleaning site. The LM Bot could also have a dust pan style opening, on the bottom or as an attachment, with a removable receptacle, to sweep rocks, garbage and debris into, to remove from the cleaning site. This dust pan could be a compartment that opens. The rear side could be hinged to bottom of LM Bot, the other side lowering until it touches the ground, like a drawbridge, for dustpan style sweeping. It could also have a sweeper brush roll and refuse collecting receptacles on the bottom, designed to sweep up small debris and garbage, in areas where broom sweeping wouldn't work as good.

All receptacles on the LM Bot, Cleaning Unit, Drones and the AMACS Base, should have an anchor point that can be latched onto by the LM Bots robotic arm (33). This allows the LM Bot to self-empty garbage, dirt, laundry receptacles (32), etc. It can perform these tasks for itself and all other systems, along with many assist type tasks that the LM Bot is able to do on Cleaning Unit, Drones and AMACS Base's behalf. The LM Bot can also be programmed to insert soap into the AMACS Base Station's Soap and Internal Vacuum Compartment (8), change bags and clean or change filters as needed, to further the AMACS hands free experience. Also, the LM Bot can have the ability to fill the Cleaning Unit with shampooing soap fluid and drain waste water, when the Cleaning Unit signals, while the Cleaning Unit is away shampooing in an area close or far away from the AMACS Base. This can help decrease down time of the Cleaning Unit, increase productivity and therein reducing the time required to shampoo or vacuum a home or facility.

Eventually it could be possible for the LM Bot to perform alternate cleaning tasks in the Private and Public sectors such as:
1. Washing, folding, hanging and putting away laundry
2. Washing and storing dishes
3. Cleaning windows
4. Cleaning yards
5. Washing vehicles
6. Cleaning streets and parking lots, etc.
7. Virtually all cleaning tasks needed that are not already completed by the cleaning unit
8. Tasks other the cleaning, any deemed necessary

Alternatively, the arm could have separate attachments that connect and disconnect at the end of the arms such as: broom grabbing hand, feather duster, Swiffer™ sweeper, squidgy, etc. The LM Bot could also have multiple attachments rotatably mounted on the end of the arm, so that cleaning implements can be rotated into use as needed. The Rotatable Array could also be a disconnectable attachment, so that multiple rotatable cleaning arrays can be used. The cleaning attachments themselves, on the rotatable cleaning arrays, could also be disconnectable and interchangeable, to put a specific set of attachments on a rotatable cleaning array, for a specific cleaning task, (broom, mop, hand). The Rotatable Cleaning Arrays (31) can be stored on board the LM Bot, in the AMACS Base Station or an alternate location.

Alternatively, a single robotic arm could split into multiple arms, each employing either single cleaning implements or rotatable cleaning array implements. Any combination of disclosed attributes could be used and still constitute the same overall design. This description in no way suggests limitations to our design, but more a suggested outline. Any alterations or additions to enclosed description, to accomplish the AMACS System Design, would still constitute the same concept.

Alternatively, the Cleaning Unit, Flight Drones and LM Bot of the AMACS System, could use tank tracks instead of wheels, feet that walk it around or any concept needed for motion, movement, propulsion or drive. The Cleaning Unit, LM Bot and Flight Drones, could also have varying movement, motion or drive speeds, for taxiing or flying to a new task location, or for slower or faster achieved cleaning tasks. The Cleaning Unit, LM Bot and Flight Drones, can also have cameras or other imaging devices, various sensors, and data processing systems to facilitate navigation and movement in an environment.

Additionally, there can be a reverse suction system, (not illustrated), as an operation of the Cleaning Unit with or without an additional suction system in the AMACS Base and the LM Bot, to expel dirt from the Cleaning Units dirt receptacle or bag. This process may be needed to lessen the need for receptacles to be emptied or bags replaced. The AMACS Base and or the LM Bot then discard the dirt. Being able to discard excess dirt in transit, also helps lessen downtime of the Cleaning Unit when the dirt receptacle or bag becomes full.

The LM Bot can clean itself, Cleaning Units and Flight Drones using various cleaning implements. Alternatively, the AMACS Base can have an extra built-in cleaning station for the LM Bot, or have a combination Universal Cleaning Station (39) that cleans the LM Bot, Cleaning Unit and Flight Drones, once they enter. The Universal Cleaning Station does this by using various cleaning, buffing (45), spraying, grinding, etc. Implements, via extendable and retractable robotic arms, protrusions and high- and low-pressure air, water and suction nozzles (42). Alternatively, the AMACS Base could transfer the shampooer head to this chamber, to robotically clean and dehair the brush roll, once it has been inserted into the AMACS Base and removed from the Power Plant. The Shampooer can also be driven into the Universal Cleaning Station for cleaning. The Shampooer Cleaning Station (40), in the Universal Cleaning Station can clean the shampooer as described in our co-pending patent application titled, “Four-Direction Scrubbing Carpet Shampooer” with U.S. Ser. No. 16/916,935, filed Jun. 30, 2020.

This Universal Cleaning Station could also be a separate unit from the AMACS Base that may or may not be able to remove and reconnect attachments to the Cleaning Units Power Plant, or for the other Bots (not illustrated).

Alternatively, the Universal Cleaning Station could be incorporated in the User propelled AMACS Base, for the purpose of cleaning not only the shampooer head, but also to clean and buff the Cleaning Unit for the User automatically once parked inside the chamber, or for Flight Drone or LM Bot, if applicable. The Universal Cleaning Station could also be made as a stand-alone unit and sold with Cleaning Unit only option, to automatically clean the shampooer, power plant and attachments, etc., for the User. As a stand-alone unit, the Universal Cleaning Station would need its own microprocessor/computer onboard, to automatically and thoroughly clean our cleaning Unit and its attachments, etc. The Universal Cleaning Station may also need this computer processor in the AMACS Base applications.

Alternatively, both the User propelled AMACS Base and or the Cleaning Unit only models could also come equipped with Flight Drones and or an LM Bot. In the case of the Cleaning Unit only line, (no AMACS Base), the Universal Cleaning Station would take on the role of the AMACS Base for the RHBPS Guidance System, navigation and production of work orders. The Universal Cleaning Station, would need to be set up and learn its position on the Digital Blueprint of the home, facility or landscape, in the same way as the AMACS Base.

### Robotic Flight Cleaning Drones, Flight/Drive Control and General Design Parameters

Our Flight Drone or Drones will be controlled, directed, operated, charged and constructed in a similar fashion as the Cleaning Unit and LM Bot. Their purpose, propulsion and maneuvering are designed for cleaning, maintenance and transport, through flight and driving on the ground or a raised surface. The drones do this by rotating a singular or a multitude of propellers, altering propeller speeds, direction of blade rotation, blade angle, etc. to fly the drones forward, backward up vertically and down through the air to complete cleaning, maintenance and transport tasks. Although these are Flight Drones, they will still keep the ability to land and drive if necessary, operating in the same way as the Cleaning Unit and LM Bot. Our Flight Drones claim all prior art in the making and operating of Flight Drones, cleaning, computers, robotics and any other craft necessary to make our designs and processes possible. The Flight Drones of the AMACS Base's main purposes are:
1. Scanning for layouts, cleanliness, object placement and composition, to help determine cleaning surface types, (carpet, tile, wood, etc.) and placement of objects, to help produce work orders and initially setup of the AMACS Base itself
2. Cleaning, Dusting, Oiling or Polishing of elevated areas that the Cleaning Unit and or the LM Bot may or may not be able to reach such as; furniture, knickknacks, counters, walls and ceilings, etc., with vacuum implements, feather or alternate design dusters, scrubbing material, cloth and or alternate material pads, etc. It could also be possible for the Flight Drones to oil wood, buff granite, etc., with the appropriate cleaning, buffing or oiling implements
3. Moving, picking up and or discarding of Objects or Equipment using the described attachments or implements, our Flight Drones can relocate, reposition or throw away objects, garbage or other Bots and Equipment, (Cleaning Unit, LM Bot).

To clean, our Flight Drones can have a built-in vacuum system, (not illustrated), with one or multiple nozzles or ports on the sides and or the top and bottom. The vacuum nozzles or ports can be stationary and or extendable and retractable along with the ability to swivel in all directions. With this, they can reach out to vacuum surfaces and capture dust that is kicked up in the dusting process. The vacuum nozzles can have changeable cleaning implements on the ends, (bristles, power brush, etc.), to help dislodge dust or grime. Also, the dusting implements could have vacuum ports built in, to capture dust that is kicked up in the dusting process (not illustrated).

Although we refer to our Flight Cleaning Bots as Drones, which ensures remote controlled operation, which is possible, our Drones can also incorporate an onboard microprocessor/computer to help compute work orders, navigate, communicate and clean more efficiently. Our Flight Drones will also incorporate an array of sensors to scan the environment, transmit and receive signals, (bump sensors, RF, LIDAR, sonar, wide band, etc.).

### How it Cleans

To dust, buff, oil, etc., objects and the building itself:
1. The Flight Drone flies up to an object or surface
2. Starts to rotate
3. Maneuvers to bring its cleaning apparatus into contact with the surface or object to be cleaned

This rotation motion enables the Drone to dust, buff and oil objects or surfaces.

### Examples

1. One or multiple feathers or alternate material dusters (38) protrude out of the sides and or top and bottom of the Drone. Once the Drone starts rotating, each dusting apparatus comes into contact with the surface or object to be cleaned over and over again, hence dusting. In this application, the vacuums would run simultaneously to intake dust being removed from objects. This process with dusting implements could also remove spider webs.
2. An oiling cloth or pad is connected to the sides and or top and bottom of the Drone. The Drone starts rotating and brings the oiling implement into contact with the surface to be oiled, hence oiling the surface.
3. A buffing pad or implement is connected to the sides and or top and bottom of the drone. The Drone starts rotating and brings the buffing implement into contact with the surface to be buffed, hence buffing the surface (the process would be similar for sanding, etc.).

The Flight Drones could also have interchangeable cutting, maintenance, cleaning, dusting, buffing, oiling, etc. Implements that are attached to the Drone and retractable. These implements could also be rotatably mounted, multi implements, attached to the end of a retractable arm, working the same way as the rotatable arrays of the LM Bot. These retractable implements, can be installed to the Drone and used at the same time as all of the other cleaning implements.

The Flight Drone could also spray or sprinkle cleaning fluids, oils and powders as needed to complete cleaning, oiling, buffing and scrubbing, etc. Tasks. Also, the Drones can self-eject, use assistance of LM Bot and or dock with the AMACS Base, so that a robotic arm, hand or other changing apparatus can remove and replace pads, cloths, oiling, buffing, dusting or alternative, disposable, non-disposable or washable implements. This process would also be the same, if the Drone has any filters or bags.

If cleaning implements, bags or filters, etc. of the AMACS Base, LM Bot, Cleaning Units or Flight Drones are washable, they can be collected by the LM Bot, or delivered by the individual machines and deposited for washing in a designated user cleaning area. Alternatively, the LM Bot can wash the implements itself. Alternatively, the LM Bot and or the individual machines could also deposit washable implements, filters or bags from the AMACS Base, Drones, LM Bot or Cleaning Unit in the Universal Cleaning Station, so the Station can robotically and automatically wash, dry in an integrated washer and dryer, (not illustrated) and deposit them for pickup and redeployment (not illustrated).

The Flight Drones can also employ interchangeable grabbing or rotatable attachments, to pick up and or reorient objects, or to operate rotatable attachments, (buffer, sander, etc.), so that the Drone doesn't have to rotate. Examples follow:
1. A retractable cable magnet or claw, like in a toy claw machine you′d see in the grocery store
2. A robotic arm with a grabbing hand or alternative cleaning implement. In the application the Drone can use cleaning attachments and rotatable arrays in the same way as the LM Bot
3. A crane boom with a retractable cable claw or magnet implement, hand, etc.
4. A buffer
5. A rotatably mounted feather duster or alternative duster array or ring that rotates around the Drone to create a dusting action while the Drone hovers without rotating
6. Any attachments deemed useful for the cleaning or maintenance process

The Flight Drones will have a camera for visual interaction, monitoring, scanning and guidance of the Drone. There will also be multiple sizes of Flight Drones employed by the AMACS System, to complete different types of cleaning, maintenance, transport, etc. tasks. Examples follow:

1. Dusting and de-cobwebbing walls would require a medium sized Flight Drone
2. Dusting glass or breakable objects could be done by a multitude of tiny Drones, so that they couldn't knock the breakable object over with the dusting process. This could make many normally, (NO CLEAN), items, cleanable by the AMACS System
3. A large Drone could be needed to transfer a Cleaning Unit or LM Bot from the 1^{st} floor to the 2^{nd} floor

The Flight Drones will have a dirt receptacle or cup to vacuum dirt into that can be emptied by removing a receptacle to dump, opening a bay door on the bottom to release the dirt or by reversing the suction of the vacuums and expelling the dirt back out of the Drones. The Drone can expel or dump the dirt outside of the building or dump the dirt directly into a garbage receptacle. Alternatively, the Drone can expel the dirt in and simultaneously be sucked up by, the Universal Cleaning Station, via built in suction ports (41) on the sides, top and bottom.

Once dirt is released, the dusting implements can be cleaned in the Cleaning station as well. This is completed when the Drone starts to spin rotating the feather or alternate dusters array, to bang the dusters into a protrusion (43) sticking out of the wall of the Universal Cleaning Station, to knock the dust off the dusters. The suction from the Internal Vacuum System (10), simultaneously sucks the dirt away. The protrusion could be stationary and the Flight Drone would have to maneuver itself over, so that the dusting apparatus comes into contact with the protrusions, as it rotates, knocking off the dust. Alternatively, the protrusions could be able to extend and retract from the wall, so that the Drone can hover and rotate in the center of the chamber, or in place. The protrusions move inward towards the Drone until they start to contact the dusting apparatus, knocking off the dust. This way the Drone only has to rotate and hover in place to bang off the dust of its dusting or cleaning implements.

The protrusions could also be rotatably mounted, to spin around the Drone and extend towards it, so that the Drone can hover in place without rotating, while the protrusions knock the dust off of the Drones dusting implements. Again, the suction simultaneously sucks the dirt away, in any combination of dust expulsion, cleaning of the Drone or its cleaning implements.

The Universal Cleaning Station could also have dusters that extend out to come in contact with the body of the Drone, to dust dirt buildup off the Drone, as it rotates while the dusting apparatus is simultaneously being cleaned. Then the dusters retract out of the Drones way once cleaning is complete.

Alternatively, the Universal Cleaning Station could have a spot with a bunch of dusters arranged to where, when the Drone flies in its surroundings, the Drone could either rotate to clean itself and or the dusters could rotate or move in a way that the Drone is cleaned, while the Drone hovers in place, or is parked. In all of the Drone cleaning examples, dusters could be substituted with any cleaning implements necessary for the cleaning process. This includes these implements being interchangeable, to clean the Drone in different ways on different occasions.

The Universal Cleaning Stations high- and low-pressure air nozzles may be used to clean off any remaining dust leaving the Flight Drones clean and ready for service. To ensure the Drones stay clean and operational, these processes can be run whenever the dirt receptacle is full, post dusting and or a cleaning cycle at set time intervals. The Drone can also self-scan, or be scanned by the AMACS Base or another Bot, for cleanliness in cases where a particular cleaning task makes it dirty to the point that cleaning is needed sooner than a normal cleaning cycle interval. Alternatively, The Flight Drones could also land and motor over a recessed waste receptacle or suction port, or land on a non-recessed receptacle or suction port, on or in the Universal Cleaning Station to dump the dirt from the belly dump opening.

The Drones could also be engaged by the LM Bot in a way that the LM Bot could anchor to the Drone to hold it still and clean it. Also, the LM Bot could clean the Drone in midflight, while parked on the ground or an elevated surface. The Drone being cleaned by the LM Bot may especially be needed after a task that involves cleaning, maintaining or buffing with a fluid or oil. The Flight Drones will have shelves (46) to park on inside the AMACS Base or at another location, but could be stored by a cycling device or anchored to the wall or ceiling inside or outside the AMACS Base. Alternate storage methods could be used, whatever is needed.

Our Flight Cleaning Drones could also be employed for tasks other than cleaning. Our Drones can employ whatever implements or tools necessary, to complete said tasks such as:
1. Tree trimming
2. Trimming hedges
3. Sanding
4. Painting
5. Pressure washing buildings
6. Carrying objects
7. Fishing
8. Picking up or delivering items
9. Watering plants
10. Any task suitable or possible

No enclosed description implies limitations to our design. Any and all combinations of described product design, use, operation or construction to achieve the AMACS System or any of its working parts, will still constitute the same design. Any modifications fairly clear to someone knowledgeable in the arts, to any part of the overall design, would still be considered our same novel AMACS System/design.

### Product Line 3

### Robotic Commercial Use

The Robotic Commercial AMACS System, is essentially the same as the Residential Home Model, but it will need some altered parameters such as:
1. The Shampooer bushes will need to be lowered down farther to clean low profile Commercial Carpet.
2. The Machine will need to be set up to withstand longer Commercial use cycles.
3. Most systems will likely consist of multiple AMACS Bases to clean larger buildings. These will also incorporate computerized cooperation between multiple AMACS Bases, Cleaning Units and LM Bots to insure efficient cleaning.

### New AMACS Head Changer—Cycling Tower

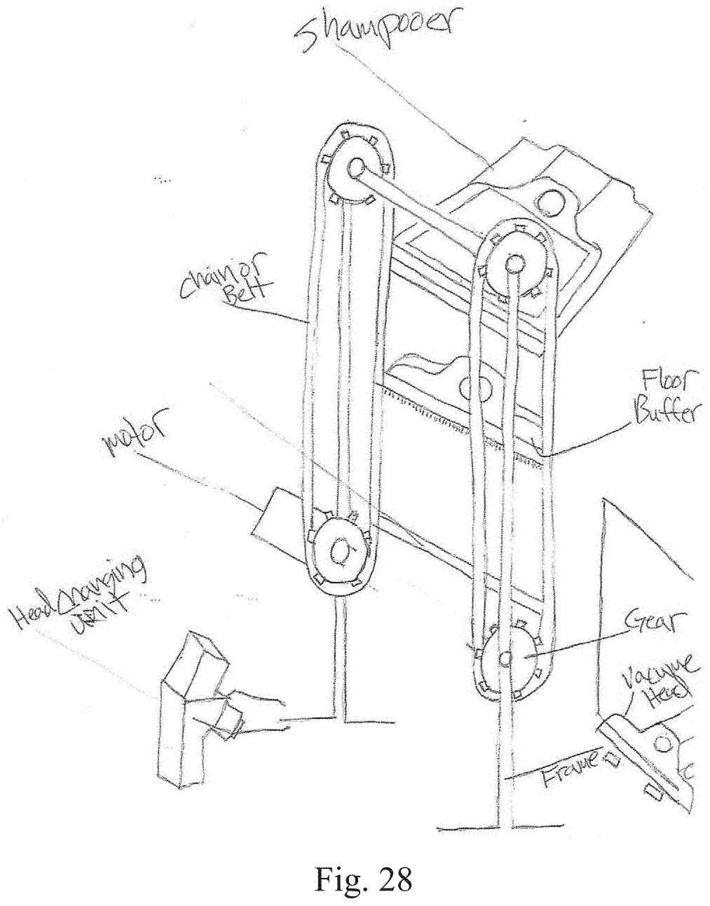

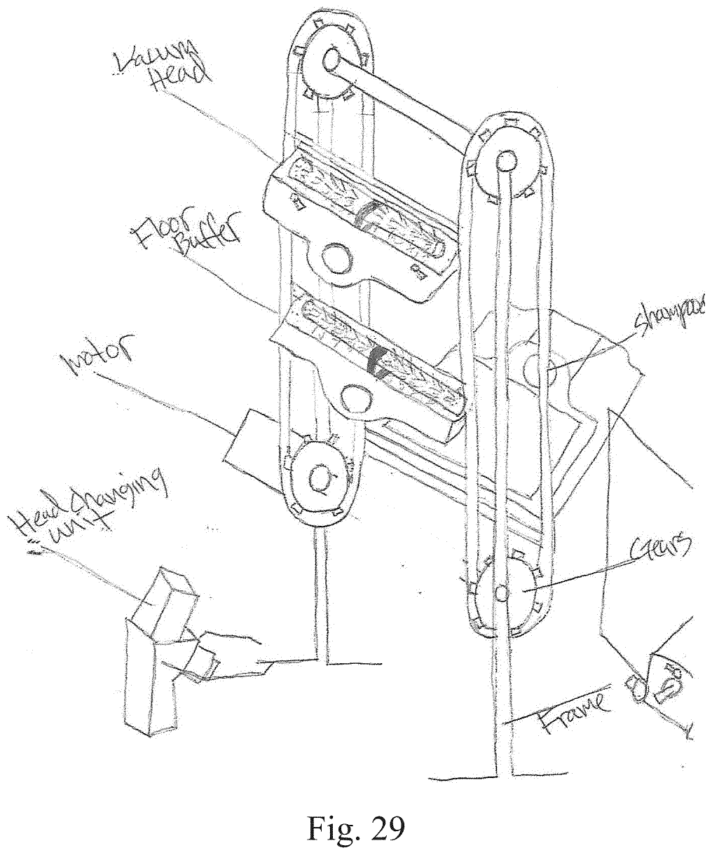

Referring to FIGS. 28 and 29, an alternative embodiment of the AMACS attachment head changer system is illustrated. This alternate cycling device is called a cycling tower. The cycling tower device includes an outer frame to support its vertical design, gear and chain or belt tracks on each side to rotate clockwise and counter clockwise to move attachments up and down into position for the head changing process, a motor to rotate the gear and chain or belt tracks, attachment bars with coinciding hanging studs and clamps to hold attachments in position when not in use and when they're turned upside down in cycling tower movement process, sensors for proper alignment and smooth attachment exchange, and a head changing unit as previously described or a combination of different units to do all the same processes as described above.

The cycling tower device of the example alternative embodiment can change attachment heads with a similar process as previously described, and use less moves while saving space without the need for shelves. More attachment heads than illustrated can be installed and used in other embodiments.

### DETAIL REFERENCE NUMBER LEGEND FOR DRAWINGS

1. Flight Drone
2. Cleaning Unit (User Propelled)
3. Robotic Cleaning Unit
4. LM Bot
5. AMACS Base Station
6. Attachment Portal
7. Touch Screen
8. Soap and Internal Vacuum Compartment
9. Attachment Head Changing Portal
10. Internal Vacuum System of the Universal Cleaning Station
11. Soap Intake Nozzle
12. Wheel Depressions
13. Hood Lifter
14. Tilting Piston Attachment Cutouts
15. Head Changing Unit
16. Shampooer Head
17. Buffer Head
18. Wheel Alignment Clamp
19. Tilting Pistons
20. Vacuum Head
21. Belt Lifter Turner
22. Attachment Lever Turner
23. Attachment Lever
24. Belt Lifter
25. Attachment Grabbing Fingers
26. Pick Points
27. Attachment Peg
28. Soap Filler Tubes
29. Head Changing Unit Slide Track
30. Retractable Shelf
31. Rotatable Cleaning Array
32. Laundry Receptacle
33. Robotic Arm with Grabbing Implement/Claw
34. Robotic Cleaning Unit Dust Receptacle
35. Robotic Cleaning Unit Air Duct
36. Robotic Cleaning Unit Air Diverter for Autonomous Shampooer Attachment
37. Canister Attachment Carousel
38. Flight Drone Dusting Implements
39. Universal Cleaning Station
40. Shampooer Cleaning Station
41. Suction Ducts/Ports
42. High Pressure Air/Water Nozzles
43. Duster Cleaning Protrusion
44. Buffer
45. Drone Shelves

The disclosure herein is in no way a statement of limitations to this patent, but rather a description of example embodiments of the novel concepts forming the various features of the disclosed invention. The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An Automatic Multi-Attachment Changing Station (AMACS) system configured to automatically change attachment heads between vacuum, shampooer and buffer on its own, the AMACS system comprising:
a cleaning unit including a power plant, wheels for self-propulsion, and a first attachment head; and
a base unit including;
an attachment head changing portal to receive the cleaning unit;
wheel alignment clamps to align and secure the wheels of the cleaning unit in the attachment head changing portal; and
a head changing unit to remove the first attachment head from the cleaning unit and to attach a second attachment head to the cleaning unit.

2. The AMACS system of claim 1 wherein the base unit is further configured to cycle through various attachments via an integrated user terminal, delivering attachments to a pick-up portal.

3. The AMACS system of claim 1 wherein the base unit is further configured to automatically fill fluids, powders, or oils, remove waste water, and clean cleaning implements and equipment as controlled by a user interface or autonomously.

4. The AMACS system of claim 1 further including a Laundry/Maintenance (LM) bot configured to pick up objects.

5. The AMACS system of claim 1 further including a Flight Drone configured to scan, dust, and clean elevated areas and surfaces.

6. The AMACS system of claim 1 further including a Robotic Home Base Positioning System (RHBPS) Guidance module configured to use a positioning signal from the base unit with two sensors for in-home trilateration, coupled with a digital blueprint of a home, facility, or landscape to guide the cleaning unit through computer generated work orders.

7. The AMACS system of claim 1 further including a Laundry/Maintenance (LM) bot configured to pick up objects, a Flight Drone configured to scan, dust, and clean elevated areas and surfaces, and a Robotic Home Base Positioning System (RHBPS) Guidance module configured to use a positioning signal from the base unit with two sensors for in-home trilateration, coupled with a digital blueprint of a home, facility, or landscape to guide the LM bot and the Flight Drone through computer generated work orders.

8. The AMACS system of claim 1 wherein the base unit is further configured to learn its position relative to a digital blueprint of a home, facility, or landscape.

9. The AMACS system of claim 4 wherein the LM bot is further configured to remove and empty a vacuum receptacle.

10. The AMACS system of claim 4 wherein the LM bot is further configured to include rotatable cleaning implements.

11. The AMACS system of claim 1 wherein the cleaning unit is further configured with a manual mode tethering device.

12. The AMACS system of claim 1 wherein the first attachment head includes a locator or microchip tag identifier.

13. The AMACS system of claim 1 wherein the base unit is further configured to include a universal cleaning station, the universal cleaning station including a plurality of cleaning implements and cleaning methods.

14. The AMACS system of claim 1 further including a flight cleaning drone configured to clean elevated surfaces.

15. The AMACS system of claim 1 being further configured to create a computer generated work order including routing information defining a path for the cleaning unit to follow.

16. The AMACS system of claim 1 being further configured to include a mobile application user interface to enable a user to control operation and view status of the AMACS system.

17. The AMACS system of claim 1 wherein the base unit is further configured to be controlled either by a user terminal or autonomously.

18. The AMACS system of claim 1 wherein the head changing unit is further configured to change attachment heads for either a user-propelled cleaning unit or an autonomous robotic cleaning unit.
